(19) United States
(12) Patent Application Publication
(10) Pub. No.: US 2016/0101426 A1
(43) Pub. Date: Apr. 14, 2016

(54) METHODS AND APPARATUS FOR THE CONTINUOUS MONITORING OF WEAR IN GRINDING CIRCUITS

(71) Applicant: FLSMIDTH A/S, Valby (DK)

(72) Inventor: Robert Evan Heinrichs, Abbotsford (CA)

(21) Appl. No.: 14/892,322

(22) PCT Filed: May 20, 2014
(86) PCT No.: PCT/EP2014/060342

§ 371 Date: Nov. 19, 2015

Related U.S. Application Data
(60) Provisional application No. 61/825,795, filed on May 21, 2013.

(51) Int. Cl. B02C 17/18; B02C 17/16

(52) U.S. Cl. CPC B02C 17/1805; B02C 17/163

(57) ABSTRACT

A system for the continuous monitoring of wear is disclosed. The system comprises a grinding mill (100) having at least one grinding disc (106). At least one detector (141) is provided to the at least one grinding disc (106), and at least one sensor (120) is provided to the grinding mill (100) which is configured to communicate with the at least one detector (141) during operation of the grinding mill (100). In use, the at least one grinding disc (106) wears away and ultimately affects a function of the least one detector (141). The at least one sensor (120) is configured to monitor said function of the least one detector (141). When the at least one sensor (120) detects a change in the signal of the at least one detector (141), an operator is notified that maintenance or grinding disc replacement may be necessary.

### FIELD OF THE INVENTION

This invention relates to equipment and processes for improving the productivity, the usable life, and the efficiency of grinding apparatus and components thereof. More particularly, this invention relates to methods of monitoring the wear of grinding components within fine grinding mills and systems and apparatus for accomplishing the same.

### BACKGROUND OF THE INVENTION

Fine grinding mills may use polyurethane-cast or polyurethane-coated grinding discs on a rotating shaft to agitate a grinding media load (e.g., such as ceramic beads) within a housing. As coarser slurry enters one end of the fine grinding mill and moves to an opposite end, it is sheared and pulverized between the grinding media and the rotating grinding discs. At the opposite end of the fine grinding mill, finer slurry exits the housing. Accordingly, particle sizes within the slurry are reduced.

One example of such a fine grinding mill is the FLSmidth® VXPmill™ vertical regrind mill (formally known as the Knelson-Deswik VGM-series mill). The mill has a series of grinding discs which rotate within a barrel-shaped vertical housing filled with grinding media to pulverize particles in coarse feed slurry. Although the mill was originally developed in South Africa for the pigment industry, it has utility in flue gas desulphurization (FGD), platinum processing, gold processing, carbon-in-leach (CIL) circuits, tank-leaching, as well as other mineral processes. The FLSmidth® VXPmill™ was adapted from a horizontal design in order to provide a smaller installed footprint than a horizontal mill. Its vertical nature also works with gravity to ensure that slurry product exiting the top end of the mill is of certain fineness. Its greater range of tip speed (e.g., between 3 m/s and 15 m/s, and more preferably 10-12 m/s) bridges the gap between lower tip speed mills (e.g., less than 3 m/s) such as Vertimill® vertical mill (which is produced and sold by Metso) and higher tip speed horizontal mills (e.g., greater 15 m/s) such as IseMill™ (which is designed and manufactured by NETZSCH and offered by Xtrata Technology). Other non-limiting examples of fine grinding mill devices may be seen in various literature including the following patents and patent application publications: US2010025512, U.S. Pat. No. 6,189,280, US2001000588, IN00819KN200, U.S. Pat. No. 5,114,083, JP2095449, JP2095450, JP2006595, JP7008824, U.S. Pat. No. 4,754,934, DE3768803, U.S. Pat. No. 4,660,776, JP2006596, KR890003745, CA1256414, IN164657, JP63199793, CN85107923, JP62265392, JP62230891, U.S. Pat. No. 4,242,002, U.S. Pat. No. 5,366,639, US2005040266, US2011303774, U.S. Pat. No. 5,797,550, U.S. Pat. No. 5,984,213, US2011309174, US2009072057, US2005051651, US2010127108, WO2010DE00234, US2009072060, EP1970124, US2003209618, EP1206971, DE10064828, WO04101154, U.S. Pat. No. 5,333,804, DE10028946, DE10064829, DE4130835, DE19832769, AU700295, AU697677, DE4421478, WO9007378, DE19510807, DE4425906, EP0504836, DE4419919, U.S. Pat. No. 4,620,673, DE4240779, EP0448100, DE2745355, DE3927076, DE4116421, U.S. Pat. No. 4,915,307, U.S. Pat. No. 4,805,841, DE3902689, EP0306921, GB1331662, DE8517645, DE8336257, U.S. Pat. No. 4,558,825, EP0074633, U.S. Pat. No. 3,993,254, GB2074895, U.S. Pat. No. 4,273,295, DE2163699, IT1001528, U.S. Pat. No. 4,089,473, GB1509591, GB1416509, FR2305225, U.S. Pat. No. 3,937,406, DE1805387, GB1179292, and U.S. Pat. No. 3,432,109, without limitation.

Depending on the volume and mass of the grinding media used within a grinding mill, the first third of the total number of grinding discs which are located closest to the slurry feed inlet typically exhibit the greatest amount of wear. In many cases, this first third comprises approximately four grinding discs. It can take 4-6 hours or more to replace this first third, and a full change-out of all grinding discs in a grinding mill (albeit, seldom necessary) takes approximately 16 hours or more. These time-consuming repair processes—if performed too often, may result in losses such as premature disc replacement, superfluous operational downtime, increased labor costs, and reduced throughput. If the repair process is performed too infrequently, other expensive losses such as shaft failure, inefficient grinding, and/or further degradation of intact discs or mill components may be incurred. Since disc wear is not visually observable in operation, a plant operator typically needs to discharge any slurry and grinding media within the grinding mill, and then gain internal access for a closer visual inspection. This takes a significant amount of time and reduces throughput. The systems and methods disclosed herein provide continuous monitoring of the state of wear of the grinding discs in-situ and during operation so that the current state of wear can be known without needing to halt the operation of the grinding mill for manual visual inspection.

There are many variations of wear management systems which have been attempted. One example of a conventional wear management system is the Krebs SmartCyclone™ system provided by FLSmidth Krebs. Other examples of conventional wear-management systems may be found in the following patents and patent application publications: U.S. Pat. No. 4,646,001, U.S. Pat. No. 4,655,077, U.S. Pat. No. 5,266,198, U.S. Pat. No. 6,080,982, U.S. Pat. No. 6,686,752, U.S. Pat. No. 6,945,098, and US20030209052.

### OBJECTS OF THE INVENTION

It is, therefore, an object of the present invention to provide a method of notifying an operator when a grinding disc has reduced in diameter by a preset amount.

It is also an object of the present invention to allow efficient proactive scheduling of maintenance based on quantitative data obtained while a grinding apparatus or circuit remains in service.

A further object of the present invention is to provide an operator with the ability to schedule grinding mill maintenance based on actual measured wear data, thereby optimizing mill capacity, throughput, % grinding media charge, grinding disc life, and manpower.

It is also an object of the present invention to improve the efficiency of current grinding circuits by extending the usable life of grinding apparatus and components thereof.

It is a further object of the present invention to provide apparatus which are configured to indicate, in real-time, whether a grinding component needs to be replaced without the need for temporary decommissioning or visual inspection.

Moreover, an object of the present invention is to provide a cost-friendly, economical way for plant owners to subsidize everyday plant operations, offset maintenance costs, justify large start-up capital expenditures, and lower overhead costs.

These and other objects of the present invention will be apparent from the drawings and description herein. Although every object of the invention is believed to be attained by at least one embodiment of the invention, there is not necessarily any one embodiment of the invention that achieves all of the objects of the invention.

### SUMMARY OF THE INVENTION

Proposed, are various systems and methods for detecting amounts of grinding disc wear within a grinding mill during its operation. Also proposed, are methods for indicating a remaining life of said discs to an operator in order to adjust/optimize maintenance schedules to reduce machine downtime.

A system for the continuous monitoring of wear is disclosed. The system comprises a grinding mill having at least one grinding disc, at least one detector provided to the at least one grinding disc, and at least one sensor provided to the grinding mill which is configured to communicate with the at least one detector during operation of the grinding mill. In use, the at least one grinding disc wears away and ultimately affects a function of the least one detector. By virtue of communication with the at least one detector, the at least one sensor is configured to monitor said function of the least one detector and determine an operational status of the at least one grinding disc. In some embodiments, the at least one detector comprises an RFID tag and the at least one sensor comprises a reader/interrogator. In some embodiments, the RFID tag may comprise a low-frequency RFID tag and the at least one sensor may comprise a low-frequency detector/identifier in the kHz range of frequencies. In some embodiments, the at least one detector may comprise an ultra-high frequency RFID tag, and the at least one sensor may comprise an ultra-high frequency detector/identifier in the MHz range of frequencies. In some embodiments, the RFID tag may comprise a microwave RFID tag, and the at least one sensor may comprise a microwave detector/identifier which operates in the GHz range of frequencies. In other embodiments, the at least one detector may comprises a magnet and the at least one sensor may comprise a Hall Effect sensor. In yet further embodiments, the at least one detector may comprise a wafer-style probe comprising a printed circuit board (PCB). In some instances, the at least one detector may comprise a radioisotope capable of emitting alpha particles and/or low energy gamma rays, and the at least one sensor may comprise a radioisotope detector/identifier, wherein the at least one sensor is configured to detect the radioisotope when the at least one detector is exposed after a predetermined amount of disc wear. The at least one detector may comprise a self-powered RF-emitting wireless micro-transmitter, and the at least one sensor may comprise a receiver tuned to the same frequency as said RF-emitting wireless micro-transmitter. In some embodiments, the at least one detector may communicate with the sensor wirelessly. In other embodiments, the at least one detector may be hardwired to the at least one sensor to facilitate communication. Multiple detectors may be provided to the at least one grinding disc without limitation, and in some instances, at least one detector may be provided to multiple grinding discs within a grinding mill. A first detector may be provided to a first grinding disc at a first radial location which is different than the radial location of a second detector in a second grinding disc.

A grinding disc for use in a grinding mill is also disclosed. The grinding disc may comprise a shaft attachment feature and at least one detector which is configured to communicate with a sensor provided to the grinding mill. In use, the at least one grinding disc may wear away and ultimately affect a functionality of the least one detector. By virtue of communication with said sensor, the at least one detector may aid in determining an operational status of the at least one grinding disc. In some embodiments, the at least one detector may comprises an RFID tag. In some embodiments, the at least one detector may comprise a magnet. In some embodiments, the at least one detector may comprise a wafer-style probe comprising a printed circuit board (PCB). In some embodiments, the at least one detector may comprise a radioisotope capable of emitting alpha particles and/or low energy gamma rays. Multiple detectors may provided to the at least one grinding disc in any conceivable fashion or pattern, without limitation. For instance, in some embodiments, multiple detectors may be provided to different radial or circumferential portions of a grinding disc. In certain embodiments, a detector may be provided to a grinding disc as a separate component within a cavity. A threaded insert, cover plug, cover cap, and/or tapered cover plug may be utilized to capture a detector within said cavity. In other embodiments, detectors may be molded into a cavity provided within a grinding disc.

### BRIEF DESCRIPTION OF THE DRAWING

To complement the description which is being made and for the purpose of aiding to better understand the features of the invention, a set of drawings is attached to the present specification as an integral part thereof, in which the following has been depicted with an illustrative and non-limiting character:

FIG. 1 is a schematic representation of a fine grinding mill employing certain non-limiting aspects of the invention;

FIG. 2 is a schematic representation of a fine grinding mill employing certain non-limiting aspects of the invention;

FIGS. 3A-3E show the functionality of components within the fine grinding mill shown in FIG. 2;

FIG. 4 is a cross-section of a fine grinding mill in operation according to some embodiments;

FIG. 5 is a schematic cross-sectional view showing a wear detector disposed within a grinding disc according to some embodiments;

FIG. 6 is a schematic cross-sectional view showing a wear detector disposed within a grinding disc according to other embodiments;

FIG. 7 is a schematic cross-sectional view showing a wear detector disposed within a grinding disc according to yet even other embodiments;

FIG. 8 is a schematic cross-sectional view showing a wear detector disposed within a grinding disc according to further embodiments;

FIG. 9a is a schematic cross-sectional view showing a wear detector disposed within a grinding disc according to yet even other embodiments;

FIG. 9b is a schematic cross-sectional view showing a wear detector disposed within a grinding disc according to yet even other embodiments; wherein the wear detector is pre-molded into a plug which is then molded into the grinding disc.

FIG. 10 shows a solid grinding disc according to certain non-limiting aspects of the invention;

FIG. 11 shows a multi-piece version of a grinding disc according to certain non-limiting aspects of the invention;

FIG. 12 shows a grinding disc according to some embodiments;

FIG. 13 is a cross-sectional view through a portion of the grinding disc shown in FIG. 11;

FIG. 14 is a top cross-sectional view showing an inner portion of a grinding disc and its function according to yet other embodiments;

FIG. 15 is a cross-section of a fine grinding mill in operation according to some embodiments;

FIG. 16 schematically illustrates a method of operating a fine grinding circuit and/or monitoring wear of a grinding mill according to some embodiments;

FIG. 17 is one non-limiting example of a software application visual client display window which may be made available to an operator of a grinding circuit;

FIGS. 18-20 are views of a rotor assembly according to various embodiments; and,

FIGS. 21-24 are grinding mills incorporating grinding members incorporating detectors according to further embodiments;

FIG. 25 shows an isometric view of a grinding mill according to some embodiments;

FIG. 26 is a detailed view of a portion of FIG. 25;

FIG. 27 is a detailed view of the grinding mill shown in FIGS. 25 and 26, without read covers installed;

FIG. 28 is a cross-sectional view of the grinding mill shown in FIGS. 25-27, without read covers installed;

FIG. 29 is a detailed view of a portion of FIG. 28 showing a side antenna read zone of the grinding mill of FIGS. 25-28;

FIG. 30 is a detailed view of a portion of FIG. 28 showing a lower antenna read zone of the grinding mill of FIGS. 25-29;

FIG. 31 is a detailed view of a portion of FIG. 28 showing a lower set of grinding discs on a grinding shaft;

FIG. 32 is a transverse cross-sectional view of the grinding mill of FIGS. 25-31 showing a cross-section of a side antenna read zone;

FIG. 33 is a detailed view of FIG. 32;

FIG. 34 is a top cross-sectional view of the grinding mill of FIGS. 25-33 showing a cross-section of a lower grinding disc employing one or more detectors within the grinding disc; and,

FIG. 35 is a detailed view of FIG. 32.

In the following, the invention will be described in more detail with reference to drawings in conjunction with exemplary embodiments.

### DETAILED DESCRIPTION OF THE INVENTION

The following description of the non-limiting embodiments shown in the drawings is merely exemplary in nature and is in no way intended to limit the inventions disclosed herein, their applications, or uses.

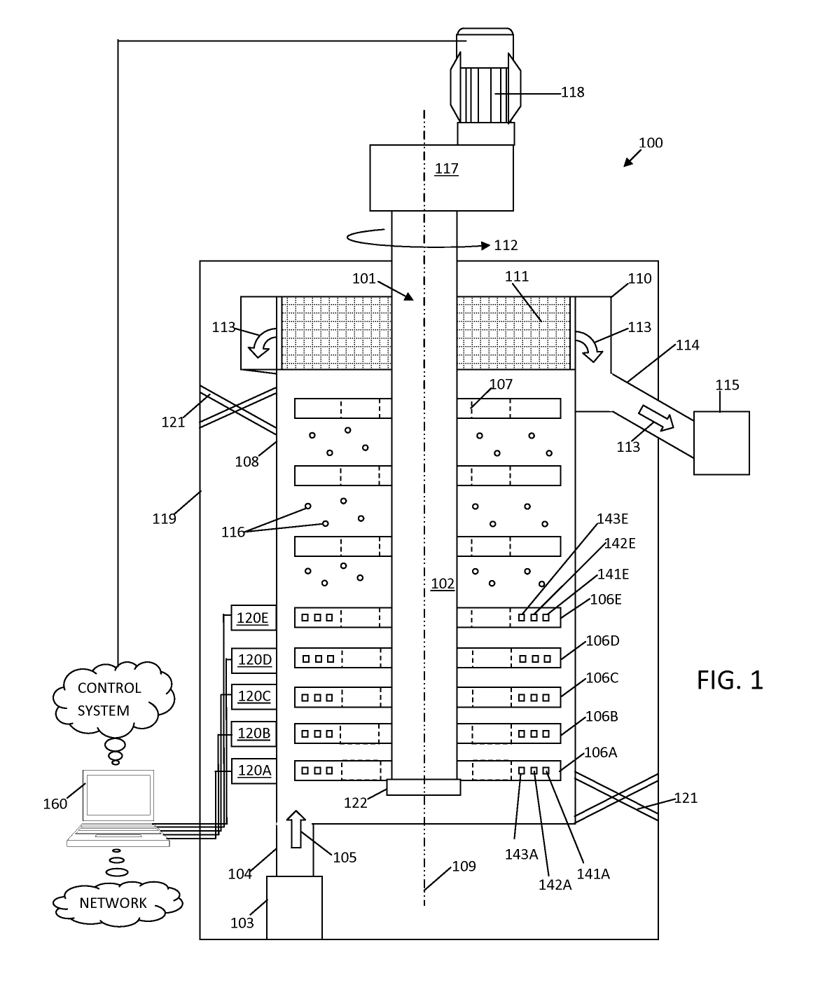

Turning to FIG. 1, a fine grinding mill 100 is shown. The fine grinding mill 100 comprises a housing 108 supported by a frame 119 by one or more structural members 121 such as trusses, beams, or angle iron. At the center of the housing 108 may be provided a rotor assembly 101 comprising a drive shaft 102 having a number of grinding discs 106a-e thereon. The drive shaft 102 is rotatable about its axis 109 in a clockwise or counter-clockwise direction 112. The grinding discs 106a-e may be spaced along the shaft in any manner or configuration and (as shown) may utilize a closer spacing towards a side of the housing 108 which is closest to incoming coarse slurry 105 fed from a coarse slurry holding device 103 through inlet 104.

The rotor assembly 101 may be driven by a drive 117 comprising one or more motors 118. In some instances, the drive 117 may comprise a grease-lubricated bearing arrangement having an upper bearing assembly (e.g., one cone and one roller bearing) and no lower bearing assembly, so that the drive shaft 102 is suspended within the housing 108 in a free-floating arrangement. The shaft 102 may be forged of steel and coupled to the drive 117 via a flanged coupling (not shown). The flanged coupling may be fixed or flexible depending on the particular application and use of the grinding mill 100. Portions of the drive 117 and housing 108 may be removed for lifting out the rotor assembly 101 and to provide access to portions of the mill 100 for repair (e.g., replacing polyurethane linings on inner portions of housing 108). Moreover, portions of housing 108 may be removed to access grinding discs 106a-e which are adjacent to the inlet 104.

The grinding discs 106a-e may be provided to the drive shaft 102 in any manner; however, in some preferred embodiments, each disc 106 is preferably bolted to one or more adjacent discs 106 and supported by respective disc surfaces for easy removal/disassembly from the shaft 102 and for wear protection of the shaft 102. In some instances, the disc 106 which is closest to the drive 117 may be bolted to said flanged coupling which is connected to the drive, and a distal end of the rotor assembly 101 may be supported with an end cap 122. The end cap 122 may be removed and the discs 106a-e temporarily supported during maintenance. In this regard, discs 106a-e may be removed with minimal disassembly of drive 117 and/or housing 108.

The grinding mill 100 further comprises a launder 110 which is separated from the inner surfaces of housing 108 by a screen 111. The screen 111 may extend partially or entirely circumferentially around the housing 108 of the mill 100 and provide an outlet 114 for finely-ground slurry 113 which is subsequently stored in a fine slurry holding device 115. The screen 111 may or may not provide particle size separations or other classifications of the fine slurry 113 exiting the mill 100 and entering into the launder 110. In some preferred embodiments, however, the screen may not provide particle size separations, but rather serve to keep grinding media 116 within the housing 108 of the mill 100.

The screen 111 may be removable from housing 108 for cleaning and/or repair, or in order to remove and store grinding media 116 during maintenance shutdown of the grinding mill 100. While not shown, one or more separate secondary/auxiliary screening systems may be provided to ensure grinding media 116 is not lost.

The volume and mass of the grinding media 116 within the housing 108 may be customized in order to establish an optimal beading load for a particular application. For example, a roughly 60% volume fill may be utilized—relative to the volume of housing 108. In some preferred embodiments, grinding media 116 may comprise ceramic-based, metallic-based, or composite beads. The grinding media 116 may be of uniform density, of non-uniform density, of uniform size, or of non-uniform size without limitation, in order to change variables such as torque on the drive 117, or surface contact with mill grinding components. Choices of grinding media 116 and/or the percent fill of grinding media 116 are preferably made to compliment particle sizes of the feed coarse slurry 105, the desired power consumption by the drive 117, and the desired rotational speed of shaft 102. Smaller grinds (i.e., smaller particle sizes in fine slurry 113) can improve leach recovery and reduce leach times; however tradeoffs may dictate the final characteristics of the fine slurry 13. For example, in some cases, a 15-18 micron grind for a fine slurry 113 may yield acceptable leaching recoveries while still providing much better efficiency than a 10 micron grind.

While not expressly shown, the drive 117 may alternatively comprise a hydraulic drive at the expense of higher noise levels when compared to electric drives. Drive 117 may comprise one or more gear reducers (e.g., between 1.5 or 2:1); or, due to the added expense and possible losses in efficiency, a gear reducer may be omitted in certain preferred embodiments. The motor 118 shown is an electric motor which may be vertically or horizontally mounted in various configurations, without limitation, and the grinding mill 100 may be configured as a short or very tall unit.

Parts of the grinding mill 100 may be fabricated from perforated plate, solid plate, tube, pipe, forged shafts, and/or molded polymers (e.g., polyurethane), without limitation. Complete or partial fabrication may be performed on a job site, or the grinding mill 100 may be delivered as a pre-assembled single unit. In some instances, the grinding mill 100 may be broken down into few manageable units and be shipped in one or more conventional size shipping container.

The housing 108 may be lined internally with polyurethane. Each disc 106a-e may be made from a steel hub having a radially-extending flange or a number of spokes or “fingers” extending radially-outwardly therefrom. The hub may be over-molded or otherwise casted within polyurethane in a mold to form a final disc product. One or more passages 107 may be provided within each grinding disc 106 to enable flow of coarse slurry 105 entering the housing 108 from an inlet 104 towards an outlet 114. The passages 107 may take the form of apertures or cutouts in a profile of the disc 106. Discs 106a-e may be provided with one or more detectors such as first detectors 141a-e, second detectors 142a-e, and/or third detectors 143a-e. One or more complimentary sensors 120a-e which are provided to the housing 108 or other portion of the mill 100 monitor a status of the one or more detectors 141a-e, 142a-e, 143a-e and deliver information (e.g., via a network) to a control system incorporating a PLC unit. In operation, when one or more of the detectors 141a-e, 142a-e, 143a-e fail due to excessive wearing of the discs 106a-e, the sensors 120a-e indicate that maintenance may be necessary and/or prompt an operator slow or stop the grinding mill 100 by reducing current to the motor 118. The exact number and particular placement of the detectors within each disc 106 may vary depending on how much wear information is preferred or to what extent control adjustments may be necessary. In the embodiment shown in FIG. 1, three detectors are shown in each disc, and one sensor is provided to monitor each disc. In such an embodiment, each sensor 120a-e may monitor, in real-time, the in-situ wear profile of its most adjacent disc 106a-e.

In some embodiments, the detectors 141a-e, 142a-e, 143a-e may comprise RFID (including LF and UHF tags) which are cast into or otherwise provided within polyurethane discs at a preset radial depth from an outermost radial profile of the disc. In other embodiments, the detectors 141a-e, 142a-e, 143a-e may comprise magnets which are cast into or otherwise provided within polyurethane discs at a preset radial depth from an outermost radial profile of the disc. Sensors 120a-e described herein may comprise an RFID reader/interrogator's antenna or a Hall Effect sensor (in instances where the detectors 141a-e, 142a-e, 143a-e are configured as magnets). For example, in some instances, a sensor 120 may comprise a printed circuit board which is operatively connected to an RFID reader/interrogator antenna that transmits signals to and receives signals from a detector 141 comprising an RFID tag. The sensor 120 may further comprise a cable connecting the printed circuit board to the antennae which is positioned at some distance away from the printed circuit board. During the operation of the fine grinding mill 100, the sensors 120a-e provided to the mill 100 (whether outside the housing 108 or embedded within the housing's internal polyurethane lining), detect the spinning detectors 141a-e, 142a-e, 143a-e embedded in the discs 106a-e. As the discs 106 wear down, they recede to smaller diameters. Eventually, at some point during operation, some detectors 141a-e, 142a-e, 143a-e may be consumed by the grinding process, at which point one or more signals provided by the detectors 120a-e to the sensors (and ultimately to the control system) are altered or no longer generated. Such changes in signaling indicate that one or more particular discs 160a-e may have worn past one or more certain predetermined amounts. Information regarding wear rates and current wear status of each disc 106 may be relayed from the sensors 120a-e to the control system reflecting the same in real-time—without any need to stop the operation, remove contents of the mill 100, or gain physical access for visual inspection. Visual warnings such as lights (green—OK, orange—Standby, red—Caution) or audible warnings such as sirens, horns, or sound-emitting diodes may be activated to alert operators of the status of the fine grinding mill 100 and components thereof. Indicators to cease operation of the mill 100, modify certain operational parameters (RPM, power, or % fill) of the mill, or replace certain worn discs 106a-e prior to excessive disc wear/failure may be provided in any conceivable fashion.

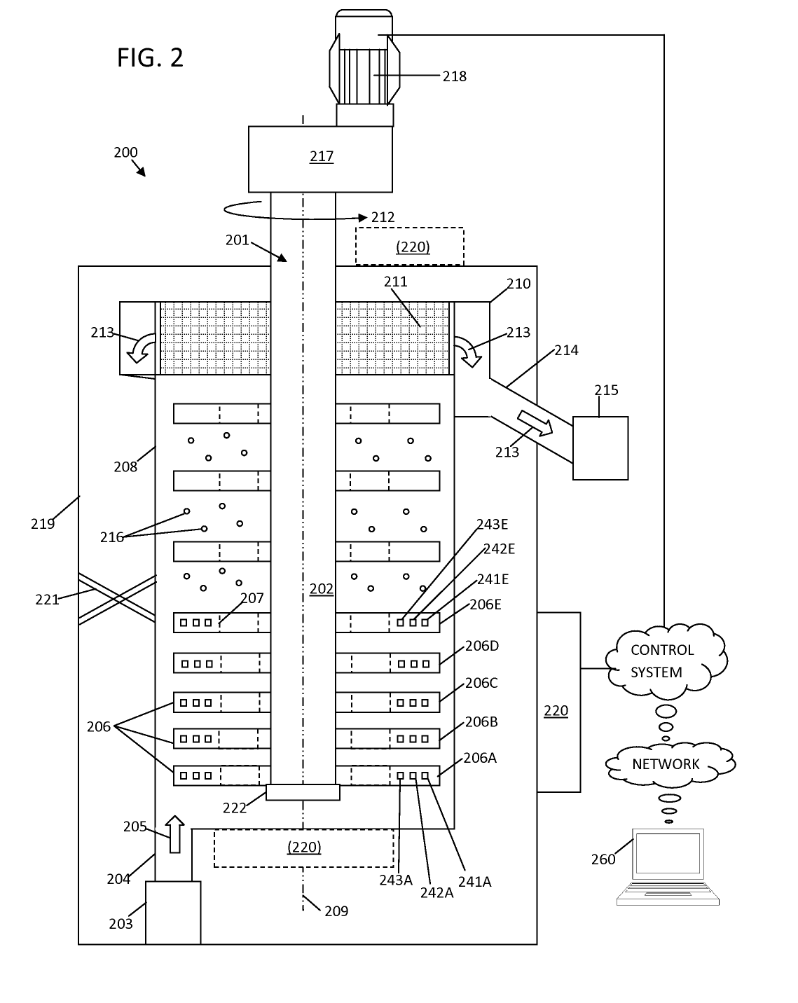

FIG. 2 illustrates a grinding mill 200 according to other embodiments, wherein a single sensor 220 may be optionally employed on one or more housing 208 and/or frame 219 portions of the mill 200. In some embodiments (as shown by dotted lines), the sensor 220 may be placed on one or both end portions of the housing such that detectors 241a-e, 242a-e, 243a-e are always within a general line-of-sight along an axis 209 of the shaft. In this regard, sensors may be able to detect the existence of detectors 241a-e, 242a-e, 243a-e without constant intermittent interruption. Such end-mounted sensors may be circular or ring-shaped—or otherwise arranged in ring formations to better track the annular path of detectors 241a-e, 242a-e, 243a-e as they rotate about axis 209. Antennas associated with sensors 220 may be oriented generally horizontally, generally vertically, and/or generally diagonally. Sensors 220 may be provided to a grinding mill 200 in any number or configuration. Sensors 220 may comprise the capability to monitor various different RFID or UHFID frequencies, and the detectors 241a-e, 242a-e, 243a-e may comprise different transponders which resonate/signal at different frequencies. In some cases, all detectors 241a, 242a, 243a on a single disc 206a may comprise a similar first operational frequency, and all detectors 241b, 242b, 243b on another disc 206b may comprise a similar second operational frequency which is different from the first operational frequency. In other cases, all detectors may operate on the same frequency, and the sensor 220 may identify each detector 241a-e, 242a-e, 243a-e based on its own unique identification (UID). For instance, detectors 241a-e, 242a-e, 243a-e may comprise unique RFID tags, and the sensor 220 may comprise a reader/interrogator and antennae tuned to a specific carrier frequency which may read the RFID tags which are tuned to said specific carrier frequency. In such instances, multiple carrier frequencies between discs may not be employed. In certain embodiments, detectors 241e, 242e, 243e which are located further from the sensor 220 may operate on higher frequencies than detectors 241a, 242a, 243a which are located closer to the sensor 220, in order to improve range and mitigate interference. In further non-limiting embodiments, all radially-innermost detectors 243a-e may operate on a first frequency, all radially-outermost detectors 243a-e may operate on a third frequency, and all centrally-disposed detectors within the discs 206a-e may operate on a second frequency, wherein each of the first, second, and third frequencies may be different from each other.

Alternatively, while not shown, in addition to one or more of the mounted or hard-wired sensors 220, handheld sensors, such as one or more handheld RFID readers may optionally be employed. In such embodiments, an operator of a grinding mill 200 may periodically check disc 206 statuses on the go, or use a single reader between different remotely-located grinding mills 200 which employ the devices disclosed herein. The handheld readers may incorporate hardware and appropriate software. The operator may simply hold the reader adjacent to the housing 208 or liner portion protruding therefrom. One or more “read zones” may be employed at predetermined locations on the housing 208. In some embodiment the read zones may comprise antenna-receiving features such as a deep channel which is sized for a read antenna to be inserted into. In this regard, sensors may get a better read on detectors without exposing sensor components to the contents of the grinding mill 200.

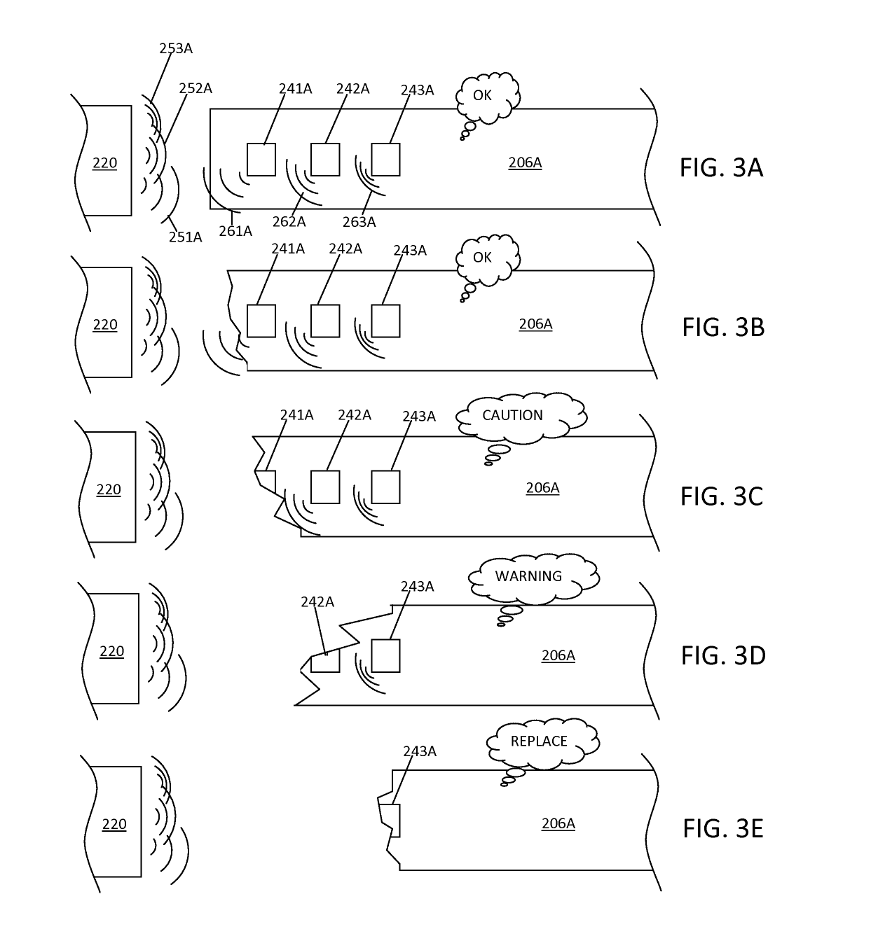

FIGS. 3a-3e sequentially show one possible example of a time lapse wear scenario for a particular grinding disc 206a within the grinding mill 200 shown in FIG. 2. Turning to FIG. 3a, a disc 206a may initially comprise three detectors 241a, 242a, 243a—each operating at different RFID or UHFID frequencies. In use, a nearby sensor 220 provided in the form of an RFID or UHFID reader/interrogator produces a first check signal 251a, a second check signal 252a, and a third check signal 253a. While the grinding disc 206a spins the detectors 241a, 242a, 243a pass by the sensor 220 and reflect first, second, and third confirmation signals 261a, 262a, 263a, respectively. FIGS. 3a and 3b show instances where all three detectors 241a, 242a, 243a are fully-operational and produce all three of the confirmation signals 261a, 262a, 263a. In these instances, the sensor 220 will relay an OK status to the control system for the grinding mill 200.

FIG. 3c shows an instance where a radially-outermost first detector 241a is being consumed by wear and is pulverized with the slurry in the housing 208. In this instance, the radially-outermost first detector 241a loses its functionality and therefore will not respond to the first check signal 251a. Accordingly, the radially-outermost first detector 241a does not produce a first confirmation signal 261a to the sensor 220, and the sensor 220 conveys this information to the control system, wherein a caution flag may be issued. As shown in FIG. 3d, both the radially-outermost first detector 241a and the middle second detector 242a are consumed by wear. In this instance, the middle second detector 242 also loses its functionality and therefore does not respond to a second check signal 252a. Accordingly, only the innermost third detector 243a produces a third confirmation signal 253a to the sensor 220. With no first 261a or second 262a confirmation signals being received by the sensor 220, and only one third confirmation signal 263a being received by the sensor 220, a warning flag may be issued. Caution/warning flags may comprise the delivery of acoustic or visual stimuli to the machine operator (e.g., via siren or colored lights), or they may comprise the delivery of electronic signals from the sensor 220 to a programmable logic controller (PLC) or central processing unit (CPU) in the control system which controls the operation of the grinding mill 200. FIG. 3e shows a situation where the disc 206a is severely warn and replacement is needed. In such an instance, all of the first 241a, second 242a, and third 243a detectors have been consumed by wear. In such an instance, none of the first 261a, second 262a, or third 263a confirmation signals are received by the sensor 220, and a warning flag indicating that maintenance is required may be issued.

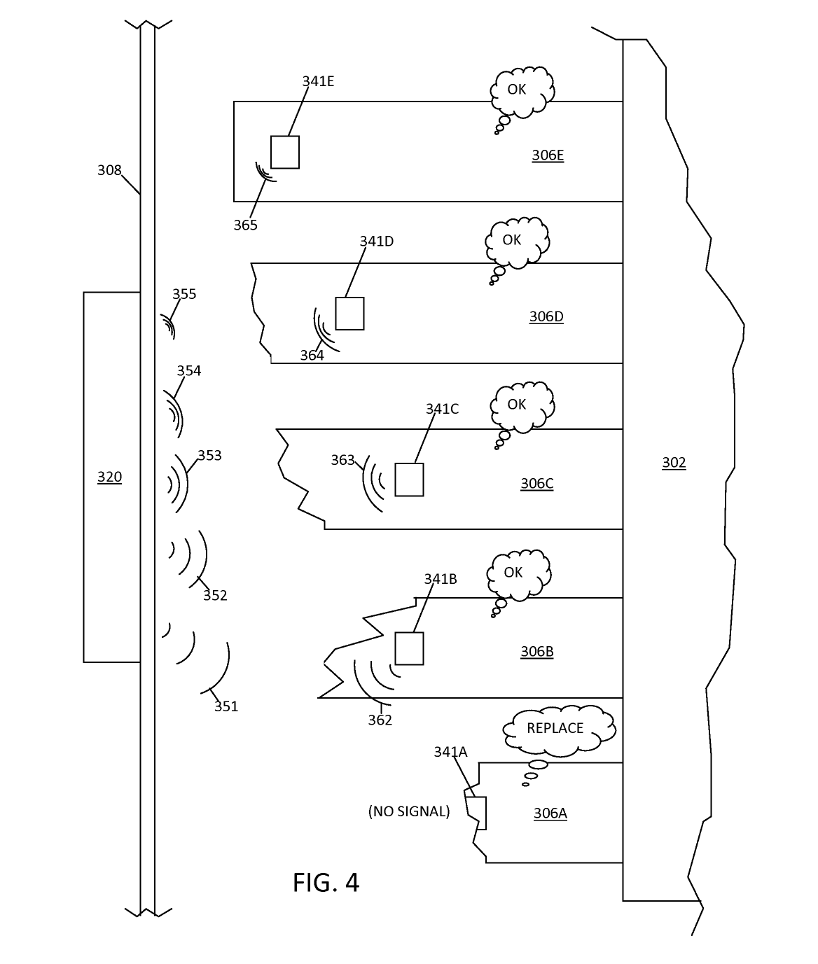

FIG. 4 shows yet another embodiment of the invention wherein each disc 306a-e comprises only a single detector 341a-e. As shown, it may be preferable to locate the radial position of a detector 341a-e within each disc 306a-e differently for each disc 306a-e, depending on a disc's location within the mill 100. For example, the radial position of a detector 341a-e within a particular disc 306a-e may be a function of how fast said particular disc typically wears out. In another example, a position of a detector 341a-e within a particular disc 306a-e may change as a function of the disc's position along the shaft 302—or in relation to the grinding mill as a whole. For instance, in the non-limiting example shown, one or more lower discs 306a which are more prone to wear may each be provided with a detector 341a located radially-inwardly and closer to the shaft 302 than a detector 341e of one or more discs 306e which are less prone to wear.

Moreover, as shown, a single sensor 320 may comprise an RFID or UHFID reader/interrogator which can operate on multiple frequencies. A first check signal 351, a second check signal 352, a third check signal 353, a fourth check signal 354, and a fifth check signal 355 may be produced. A first grinding disc 306a may be outfitted with a detector 341a capable of operating on the same frequency as the first check signal 351; a second grinding disc 306b may be outfitted with a detector 341b capable of operating on the same frequency as the second check signal 352; a third grinding disc 306c may be outfitted with a detector 341c capable of operating on the same frequency as the third check signal 353; a fourth grinding disc 306d may be outfitted with a detector 341d capable of operating on the same frequency as the fourth check signal 354; and, a fifth grinding disc 306e may be outfitted with a detector 341e capable of operating on the same frequency as the fifth check signal 355. In the instance shown in FIG. 4, the detector 341a on the first disc 306a is worn away and therefore, it does not produce a first confirmation signal 361 or an equivalent response to sensor 320. Therefore, a control system would be informed that the first grinding disc 306a needs replacement and an operator would be alerted of the same. The detectors 341b-e in the second 306b through fifth 306e discs would still provide second 362, third 363, fourth 364, and fifth 365 confirmation signals, respectively. Therefore, a control system would report a status of each of the second 306b, third 306c, fourth 306d, and fifth 306e as being fully operational.

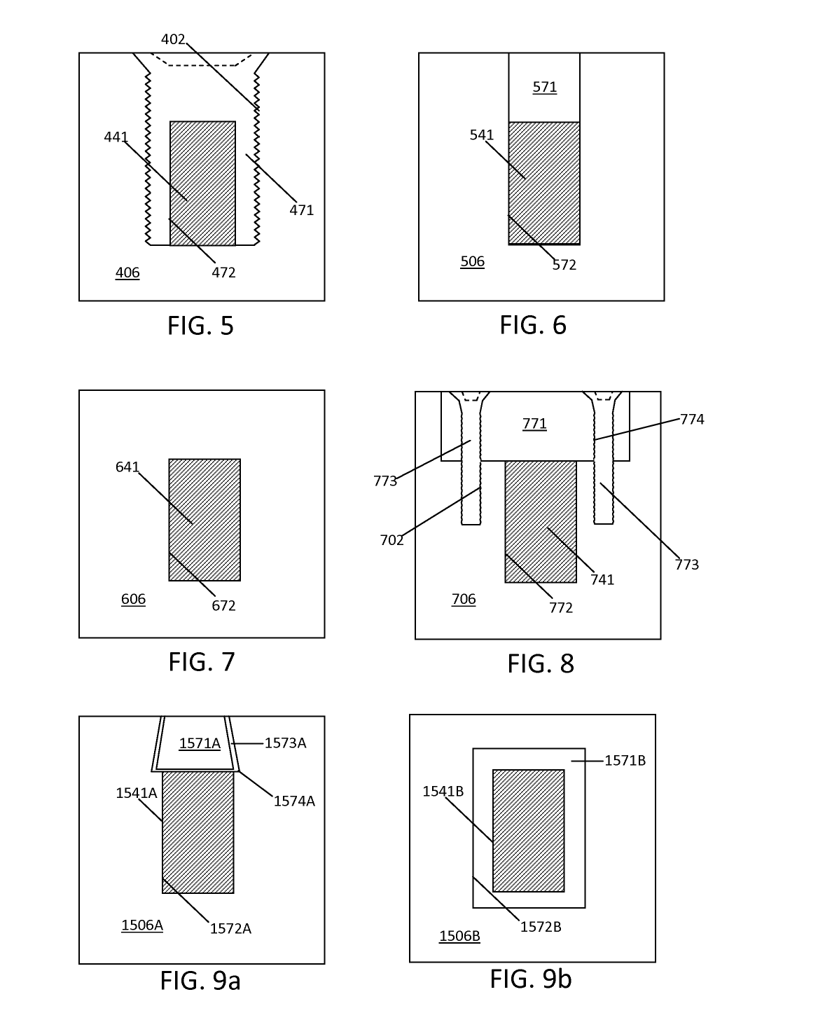

FIGS. 5-9 suggest various, non-limiting methods of embedding a detector 441, 541, 641, 741 in a grinding disc 406, 506, 606, 706. As shown in FIG. 5, a threaded insert 471 having a cavity 472 therein may be threaded into a threaded receiving portion 402 provided in a grinding disc 406 in order to capture a detector 441 therein. Alternatively, as shown in FIG. 6, a detector 541 may be placed into a cavity 572 within a disc 506, and a cover plug 571 may be placed over it and glued, welded, or otherwise bonded to the rest of the disc. While not shown, cover plug 571 may incorporate several snap fit features, or the cover plug 571, itself, may be a snap-fit fastener which complimentarily mates with features provided in the disc 506. Moreover, portions of the disc 503 surrounding the cover plug 571, or portions of the cover plug 571 may comprise surface textures, grooves, channels, or protuberances for improved friction or to allow ingress of bonding means such as an adhesive. Even more alternatively, as shown in FIG. 7, a detector 641 may be embedded in a cavity 672, co-molded with, or cast into polymer (e.g., polyurethane) disc material to form a grinding disc 606. Furthermore, as suggested in FIG. 8, a cover cap 771 may be placed over a cavity 772 in a disc 706 in order to capture a detector 741 therein. The cover cap 771 may be provided with at least one aperture 774 configured to receive and retain fastening means 733 which engages at least one threaded receiving portion 702.

As shown in FIG. 9a, a detector 1541a may be placed into a cavity 1572a within a disc 1506a, and a tapered cover plug 1571a may be placed over it and glued, welded, or otherwise bonded to the rest of the disc 1506a with bonding means 1573a. While not shown, tapered cover plug 1571a or surrounding portions of the disc 1503a may be textured for improved friction or to provide bonding means 1573a with larger contact surface area. Furthermore, while not shown, channels or protuberances may be provided on outer surfaces of tapered cover plug 1571a to allow ingress of bonding means 1573a. While in the particular embodiment shown, the tapered cover plug 1571a comprises a reverse (i.e., undercut) taper, the tapered cover plug 1571a may alternatively comprise a lead-in taper. In some preferred embodiments, a reverse taper comprising between approximately 0 and 2 degrees may be employed. The tapered cover plug 1571a may be inserted with force into a complimentary tapered cavity 1574a provided to the disc 1506a as shown, in order to provide additional pull-out resistance.

As shown in FIG. 9b, a detector 1541b may alternatively be pre-molded into a plug 1571b or similar subassembly which may then be placed or otherwise positioned into a mold and over-molded to form a complete disc 1506b. Alternatively, a cavity 1572b may be pre-formed within a molded disc 1506b, the cavity 1572b being a blind or through hole. The pre-molded plug 1541b may be positioned into the cavity 1572b by interference fit, adhesive, weld, over molding, or other mechanical fastening means.

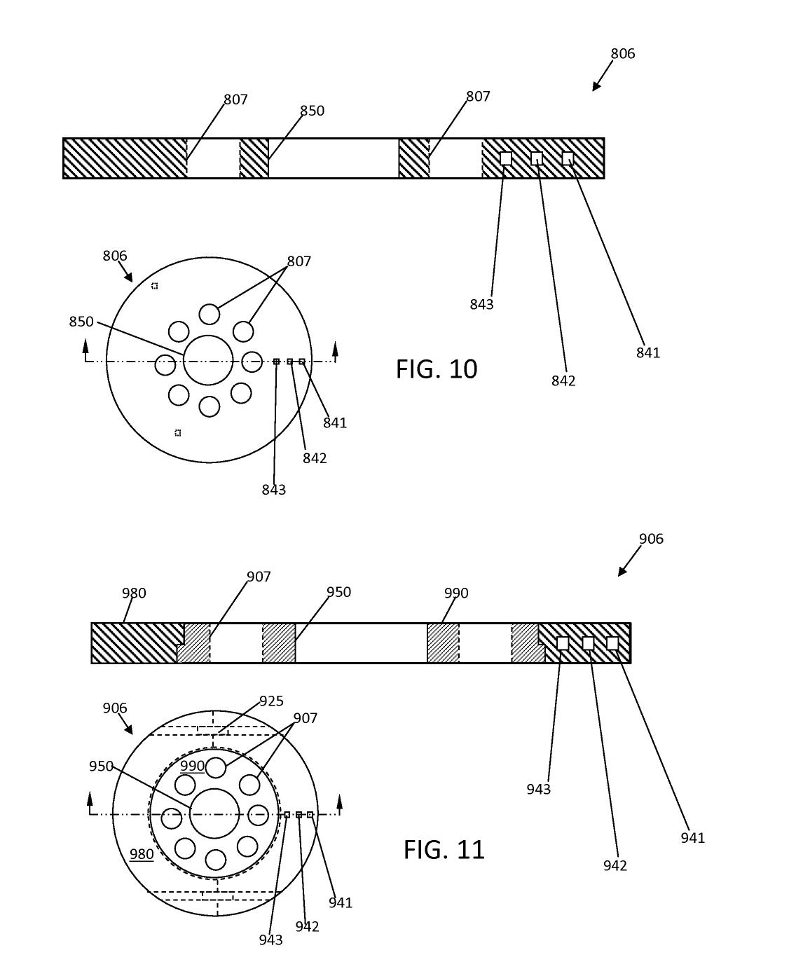

FIG. 10 shows a cross-sectional and plan top view of a single-piece grinding disc 806 according to some embodiments. The disc 806 comprises one or more detectors 841, 842, 843 therein, one or more passages 807, and a surface or other means 850 for mounting or attaching to a shaft and/or adjacent grinding disc. As suggested by dotted lines, detectors may be arranged in various circumferential patterns and spacings and do not require alignment along a single radial direction. In some preferred embodiments, the outermost detector 841 may be positioned a radial distance from the center of the disc 806 which is between approximately 80% and 100% of the outer radius of the disc 806. In more preferred embodiments, the outermost detector 841 may be positioned a radial distance from the center of the disc 806 which is between approximately 90% and 100% of the outer radius of the disc 806, for example, approximately 95% of the outer radius of the disc 806. In one non-limiting commercial embodiment, a disc 806 may, for instance, have an outer radius of 460 mm, and an outermost detector 841 within the disc 806 may be positioned at a radial distance within the disc 806 of approximately 435 mm. It should be realized that detectors may be placed in any quantity at any radial distance from the disc 806 center, without limitation.

According to yet other embodiments such as the one shown in FIG. 11, a grinding disc 906 according to the invention may comprise a “multi-piece” disc composed of a non-wear central hub or inner portion 990 and at least one outer sacrificial portion 980 comprising one or more detectors 941, 942, 943 therein. The outer portion 980 may be configured to be quickly changeable as a consumable wear element (of the more permanent inner portion 990) and optimized for quick changes. The outer portion 980 may be a single annular piece, or (as suggested by dotted lines) may be comprised of a plurality of portions of an annulus which can be joined together in clamshell fashion using fastening means 925 such as hardware (screws, nuts, bolts, washers), adhesives, or plastic welding without limitation. In instances where the outer portion 980 is a solid piece, the relative diametrical sizes of inner portions 990 of adjacent discs 906 may be varied or staggered to allow certain outer portions 980 to pass over certain inner portions 990 during the removal and installation of outer portions 980.

Other variations of the invention may include the process of refurbishing a used inner portion 990 by re-casting. For instance, an inner portion 990 comprising a metallic spoked hub may be subjected to water blasting, grit blasting, or burn-off to remove residual outer portion 980 which may comprise a urethane. The removal process may be followed by a re-casting step, wherein a new outer portion 980 is formed to the prepared inner portion 990 to form a completed grinding disc 906. During or after the re-casting step, one or more detectors 941, 942, 943 may be deposited within the urethane of the outer portion 980.

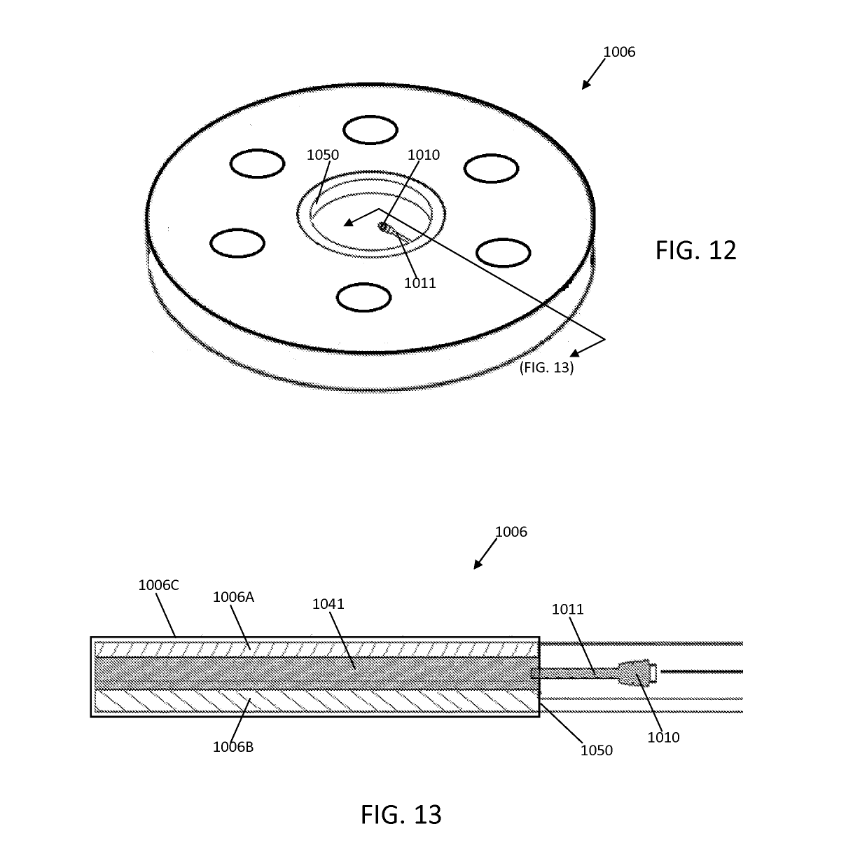

According to yet other embodiments such as the one shown in FIGS. 12 and 13, detectors 1041 may be configured to work with a sensor that is provided within a shaft of the grinding mill or otherwise operatively-connected to a rotating shaft. Accordingly, data may be received from the detector 1041 without interruption from intermittent tangential passes with each orbit of the detector 1040. In such cases, a grinding disc 1006 may be comprised of a wafer-style wear plate detector 1041 provided between a first sandwich portion 1006a and a second sandwich portion 1006b. The composition may be covered with or subsequently overmoulded with an optional outer polyurethane coating 1006, or the detector 1041 may be placed in a mold that is filled with polymeric material to form the entire disc 1006. The first sandwich portion 1006a and/or the second sandwich portion 1006b may comprise pre-formed polymer components (e.g., polyurethane) which are bonded or otherwise mechanically joined to each other to form a single-piece disc 1006. A wire 1011 extending from the wear plate 1041 may communicate with a sensor (not shown) via a hard-wired connection 1010.

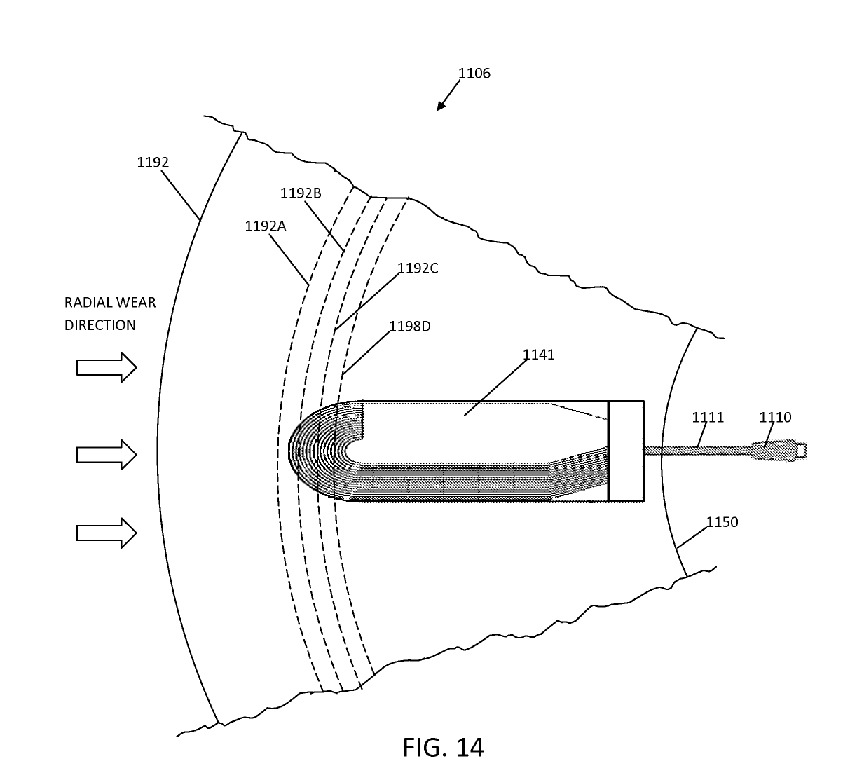

According to further embodiments, as shown in FIG. 14, a disc 1106 may comprise a probe-style wear detector 1141 having a series of parallel circuits, to which a known voltage is applied. The detector 1141 may be placed within a grinding disc 1106 at a predetermined spaced distance from an outer edge 1192 when new. In use, as wear on the disc 1106 progresses to a first wear line 1192a, no measurable changes are detected by the detector 1141 since the current in each of the circuits remains the same. Accordingly, a sensor (not shown) connected to the detector 1141 via a wire 1111 and hard wire connector 1110 would not indicate a change in operational status to a control system and would not trip an alarm. However, as wear progresses further, to a second wear line 1192b, outer portions of the detector 1141 will begin to erode away, disrupting outer-most circuits within the detector 1141. This, in turn, causes currents the remaining circuits of the detector 1141 to change. As wear continues to the third 1192c and fourth 1198d wear lines, the current through each remaining intact circuit may substantially increase until it exceeds a preset threshold or the detector 1141 ceases to function properly at all—at which point maximum recommended wear has been realized. The selected preset threshold should be indicative of a proper time to replace the disc 1106 based upon its outermost radial dimension or profile 1192 when new, and/or engineering requirements. When selecting a preset threshold, careful consideration should be given to achieve maximum use life of a grinding disc without negatively affecting efficiency.

In some embodiments, both the wafer-style 1041 and probe-style 1141 detectors may be comprised of specialized very-thin printed circuit boards (PCBs) which may be waterproof to IP 68 and may operate at temperatures between −20° and +80° C. A power supply (e.g., 12 VDC with a 20 mA maximum current) may be employed to power the detectors 1041, 1141 directly, or the detectors 1041, 1141 may be powered indirectly via a serial bus with the sensor, control system, or network. Other voltages and currents are envisaged, depending on the specifications of the particular detector being used. In some instances, power may be supplied to the detectors 1041, 1141 via a combined power & data cable which connects to a sensor, control system, or network. Alternatively, the detectors 1041, 1141 may be stand-alone battery-operated devices that communicate with a sensor, control system, or network via ZigBee® wireless standards (802.15.4), or other wireless protocol (e.g., an IEEE 802.11-based standard). Portions of the sensor, control system, or network may be provided within a rotating shaft 102 of the mill 100, or otherwise operatively-connected to a rotating shaft 102 via a brush-type contact or similar arrangement commonly used in electric motors. Moreover, portions of the sensor, control system, or network may be provided within or to inner or outer portions of the housing 108 without limitation.

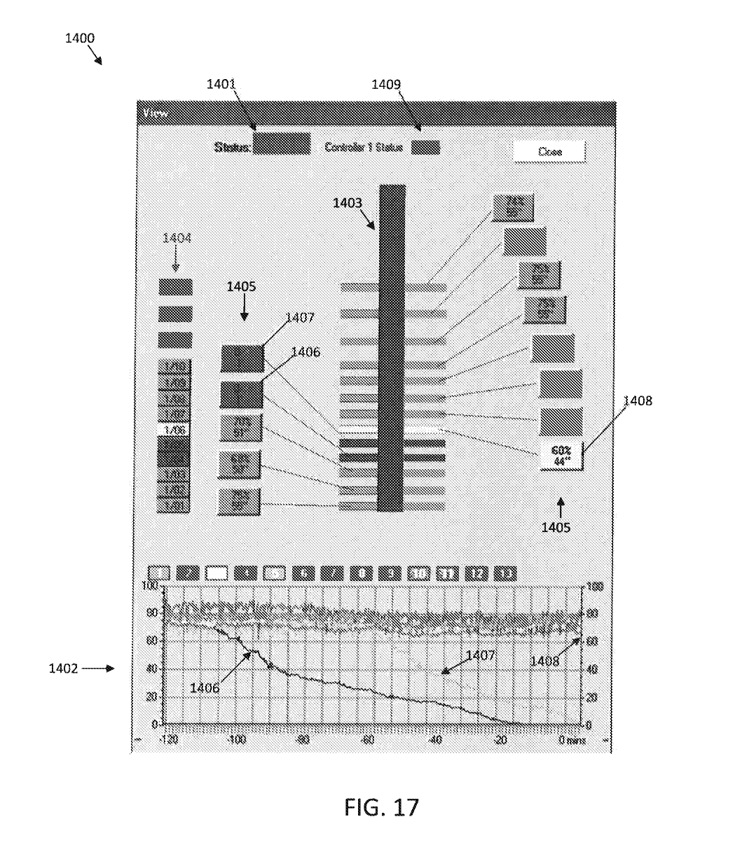

A human machine interface (HMI) computer may be provided to serve as the gateway between the detector/sensor hardware and larger grinding circuit/plant operations. The HMI computer may have multiple network interfaces—for instance, at least one for a dedicated grinding disc wear-monitoring network, and at least one for the entire grinding circuit/plant network. Alternatively, the HMI computer may run completely independently of any grinding circuit/plant network. One or more software components may be installed on the HMI computer which will allow it to perform all the necessary functions for display, analysis, and alarm management, as well as data reporting and historian functions. Input processing may be facilitated by “unsolicited” transmissions from each sensor 120a-e with data corresponding to detectors, and therefore, each sensor 120a-e may have its own unique ethernet (IP) address and may communicate via a dedicated ethernet network to the HMI computer/control room PC. Data may be retrieved from the detectors 141a-e, 142a-e, 143a-e, and accumulated in each sensor 120a-e until a set interval, at which point the sensor may send a block of data to the HMI computer/control room PC. Software on the HMI computer or control room PC may intercept the block of data, and “unpack” it into OPC tags which can be made available to all other internal and external users. Data points stored in the OPC tags may be configurable, and can be logged to a SQL database for future analysis. A data historian and analysis console may be made available for the review of past disc wear performance. With such a console, data may be compared visually in a large number of different two-dimensional and/or three-dimensional charts and graphs. Data may also be provided in its raw format, for viewing and copying for export to other programs. Data can be retrieved for one or many detectors, sensors, grinding mills, hardware units, or grinding circuits. In some embodiments, the time period of the aforementioned interval can be selected, from a few minutes to as long as the system has been in operation, provided there is adequate hard drive space for the data. An alarm manager may also be provided if customized and detailed alarm control is desired from the HMI computer. For example, a “basic” alarm mode may be provided as a default, wherein the visual display client (FIG. 17) shows various discs of a schematic rotor assembly changing colors from green, to yellow, to red, depending on the condition of the detectors therein. Levels and thresholds may be preselected and defined during system configuration. Advanced alarm management may also be provided, wherein once active, alarm conditions can be set with delays, escalations, or even sequences of conditions. Responses can vary from simple messages to external (e.g., email notification, pager notification, cell phone/text, etc.) communications. Real-time data and system status may be displayed on the visual display client, which can be viewed from the HMI computer, or from any other CPU on the plant's network which can access the OPC data on the HMI computer. The visual display client may display plant-wide status views with color codes for overall grinding circuit status, mill status, grinding disc status, detector status, or sensor status. In some embodiments, any sensor can be selected for individual viewing with a mouse click from within the visual display client. Sensor views may show individual detector readings for each disc, with colors indicating status and current or past performance (e.g., current or past wear rate, current wear amount, current disc diameter/radius, or expression of life remaining). In addition, individual grinding discs can be selected, using mouse clicks, to display detailed status information for those readings which are not normally displayed on other higher-level views (such as the overall grinding circuit operation views and/or grinding mill operation views). A rolling graph may be displayed, which, in certain embodiments may show trends for up to 24 previous hours or more. Communication services may be provided which output OPC tag values to, for example, a CHIP or PI system, or another OPC capable server. The tags can be individually selected for output, and the names of the tags on the target system can be specified for each tag. Alternately, an external OPC server capable of soliciting communications using OPC/DA can request the tag data from the HMI computer directly. OPC “Tunneling” programs, such as Matrikon, PI Tunneler, or OPC Mirror (provided by Emerson Process management), may further be used to establish secure links to the HMI computer in order to retrieve data.

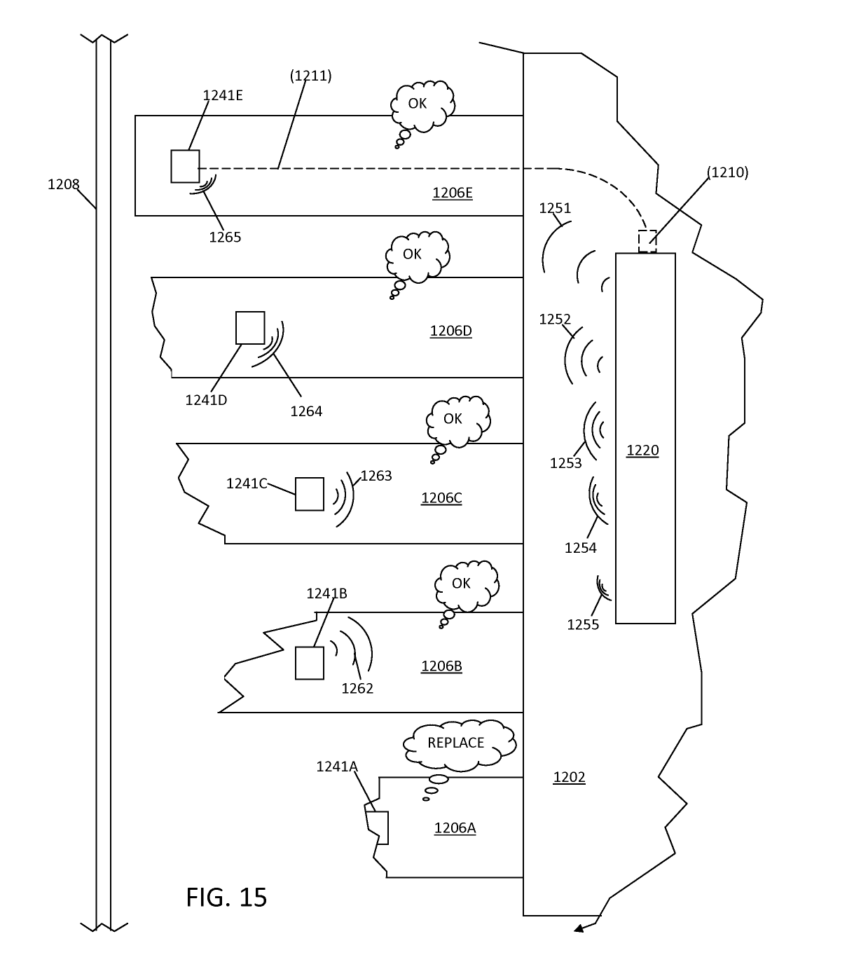

In some embodiments, sensors may collect and process data from the detectors installed in the discs periodically (e.g., every 5 or 10 seconds) and communicate the data to a controller (e.g., HMI computer) on its data bus. Depending on the type of detectors used, sensors may provide power, data acquisition, data processing, and configuration/optimization capabilities. Detector-to-sensor communication may be either cabled or wireless (as suggested in FIG. 15), with up to several detectors (of various types) per sensor. In some non-limiting embodiments, sensors may be housed in a factory-sealed polymeric box exceeding a UL94-HB flammability rating and means for mounting may be provided to the box for mounting to various components of a grinding mill, such as to a housing 108, 208, 308, 1208. In some non-limiting embodiments, sensors may hold up to NEMA 4X/IP 65 tests, operating temperatures from −20° to +60° C., and storage temperatures ranging between −40° C. and +80° C. In some non-limiting embodiments, sensors may run on 12 or 24 VDC (0.2 Amp) isolated power supplied through a bus cable. Sensor bus communications/data protocols may comprise an RS-485 multidrop network with 15 KV ESD and transient protection. In some embodiments, shielded DeviceNet cables may connect sensors with up to 16 grinding discs per grinding mill 100 or grinding circuit. Means may be provided to allow firmware to be field-upgraded using built-in bootload capability.

As seen in FIG. 15, one or more sensors 1220 may be provided to the shaft, rather than housing 1208. Wireless RFID or UHFID communication can be made between one or more detectors 1241a-e located on one or more grinding discs 1206a-e and the one or more sensors 1220 as shown. Alternatively, hardwired connections 1210, 1211 similar to the ones shown in FIGS. 12-14 and described above may be optionally utilized. In some embodiments, the wires 1210 may comprise shielded cables, waterproof cables, chemical tolerant cables, and/or abrasion-resistant cables which connect one or more detectors 1241a-e to the more sensors 1220 as shown. Alternatively, the hardwired connection may be made directly with an adjacent control system/network which incorporates the functionalities of a sensor. In some embodiments, hardwired connection 1211 may comprise USB (e.g., standard, mini, or micro plugs) or other type of serial bus connections. While not shown, the bus hardwired connections 1210, 1211 may incorporate daisy-chain geometries between adjacent discs to minimize cable runs through the shaft 1202.

Regarding controls, one or more tactile dome switches may be provided on a front overlay of each sensor to provide entry and navigation for a sensor configuration mode. Such means may provide the setting of a sensor address (e.g., #1, 2, 3, . . . , N) as well as customization and optimization of all detectors connected to that sensor. The sensor may remain attached to the bus throughout configuration, and in most instances, will not likely interfere with normal operation of other sensors.

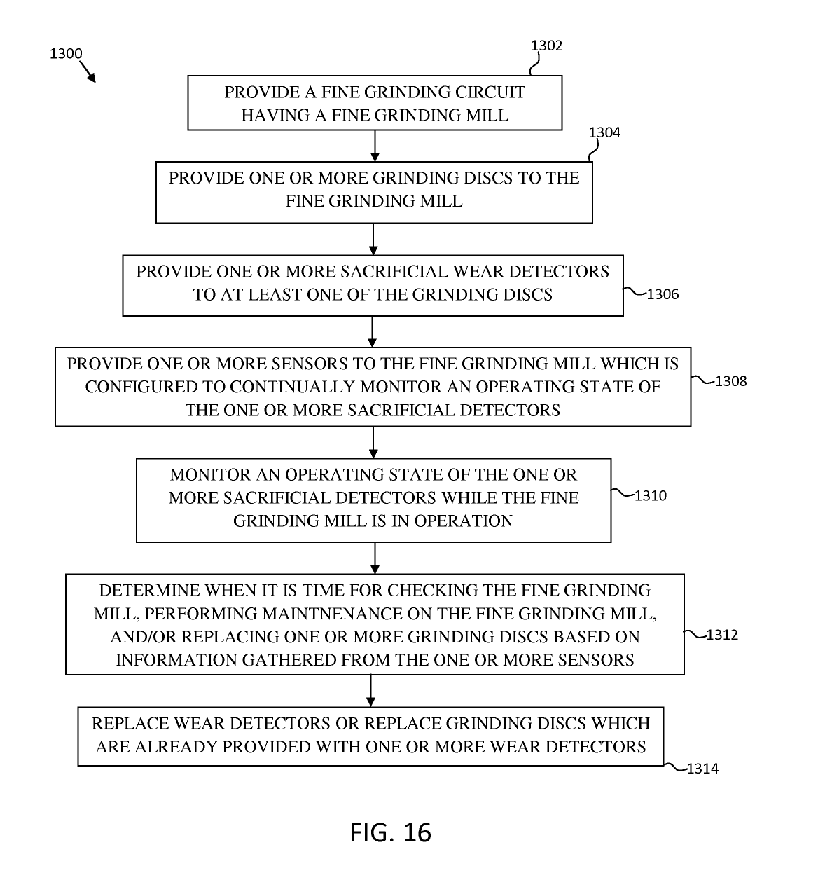

FIG. 16 schematically illustrates a method 1300 for the continuous monitoring of wear in grinding circuits according to some embodiments. The method 1300 includes the steps of providing a fine grinding circuit 1302 having at least one fine grinding mill, providing 1304 one or more grinding discs to the fine grinding mill, providing 1306 one or more sacrificial wear detectors to at least one of the grinding discs in any number or fashion, providing 1308 one or more sensors to continually monitor an operating state of the detectors provided, monitoring 1310 the state of the detectors while the grinding mill is operating, determining 1312 when it is an appropriate time to repair, replace, or check a disc or otherwise modify operational parameters based on information provided from the detectors and sensors, and attending 1314 to the problem with the correct solution (e.g., replacing worn disc(s) or slowing the machine RPM down).

FIG. 17 shows one particular non-limiting embodiment of a visual client display 1400 which may be utilized when practicing the invention. The display 1400 comprises an image 1403 which is representative of a rotor in a grinding mill, a status icon 1401 indicating an overall condition of the rotor, one or more icons 1049 indicating a status of the controller, a graph 1402 showing real-time wear for each disc on the rotor, a set 1404 of disc number icons, a set 1405 of disc status icons, and an icon 1409 showing the overall condition of a sensor. In the particular example shown, numeral reference 1406 suggests that the #4 disc of grinding mill #1 needs replacement via a red disc status icon and an indication of 0% wear life remaining. Numeral reference 1407 suggests that a #5 disc in grinding mill #1 disc needs replacement via a red disc status icon and an indication of 0% wear life remaining. Numeral reference 1408 suggests that the #6 disc will soon need replacing by showing a yellow disc status icon and an indication of 60% wear life (e.g., 44 inches of diameter) remaining.

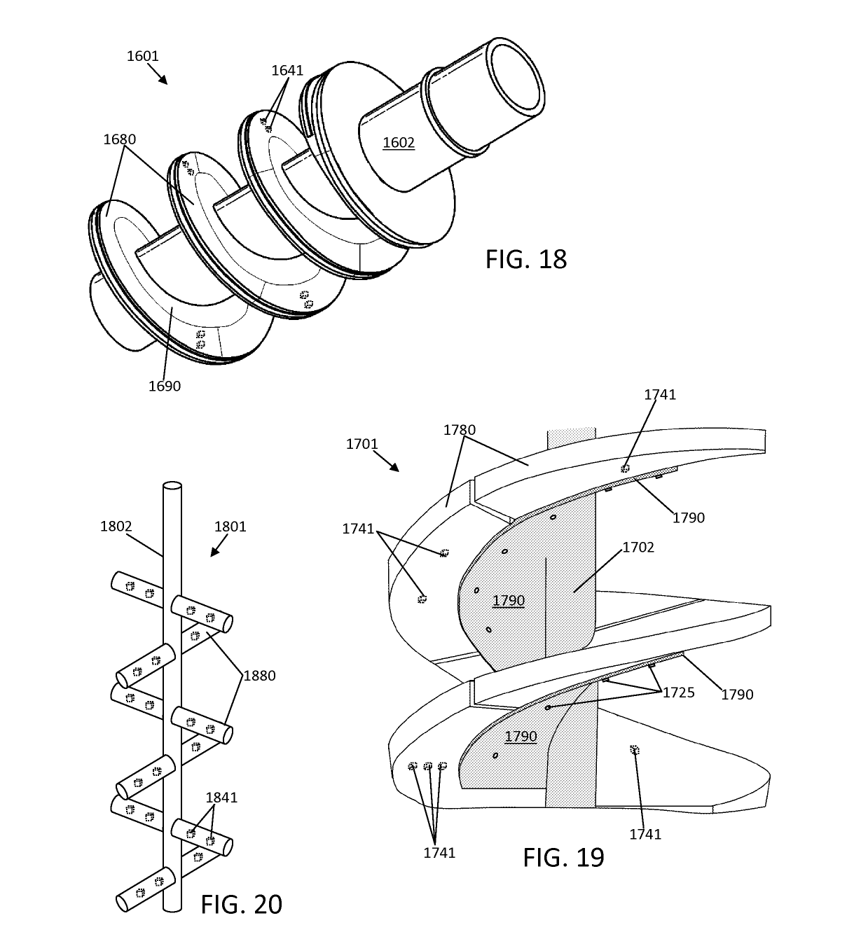

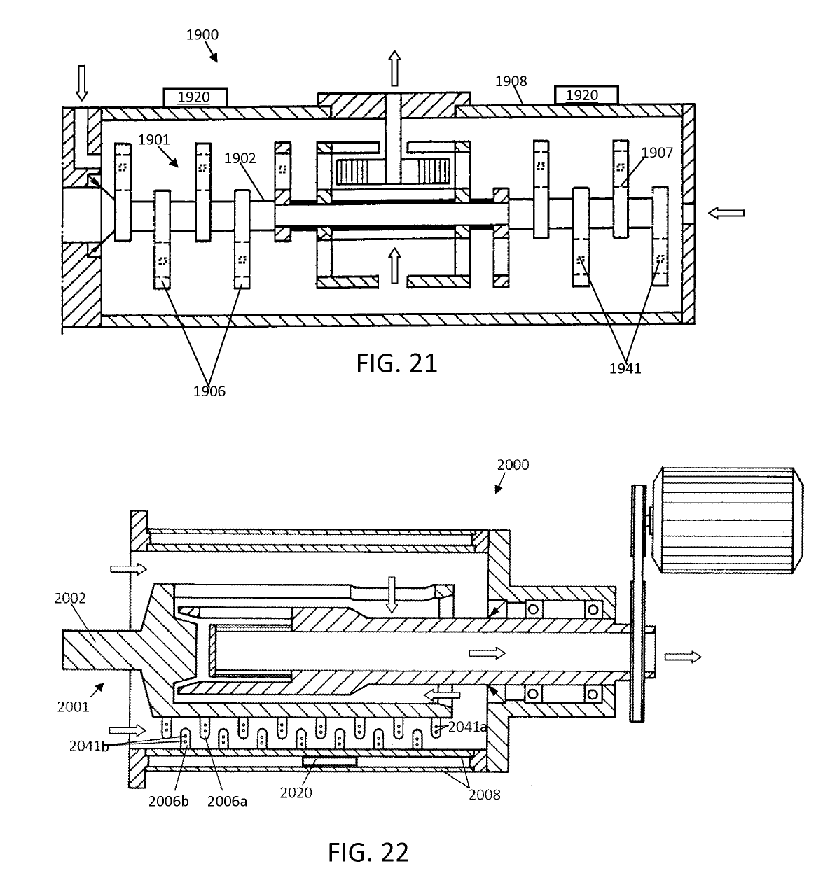

FIGS. 18 and 19 show further embodiments of auger-type rotor assemblies which may be used in a grinding mill. Turning to FIG. 18, a rotor assembly 1601 comprises a shaft 1602 and an inner portion 1690 defining a helical flange protruding from said shaft 1602. Multiple segmented outer portions 1680 may be attached to radially outer edges of the helical inner portion 1690. The outer portions 1680 may serve as consumable wear items to protect the inner portion 1690 from wear. Any of the outer portions 1680 may comprise one or more detectors 1641 disposed therein. Turning to FIG. 19, a rotor assembly 1701 may be provided which similarly comprises a shaft 1702 and an inner portion 1790 defining a helical flange protruding from said shaft 1702. One or more segmented outer portion 1780 may be bolted or otherwise fixed to an upper flank of the helical inner portion 1790 using fastening means 1725. Fastening means 1725 may comprise any known devices for connecting two components, including, but not limited to, hardware (bolts, nuts, washers, locking washers), welds, or adhesive without limitation. Any of the outer portions 1780 may comprise one or more detectors 1741 disposed therein in any desired configuration. FIG. 20 suggests yet another embodiment, wherein a rotor assembly 1801 for a grinding mill comprises a shaft 1802, and one or more grinding arms 1880 extending therefrom. The grinding arms 1880 may comprise spoke-type stirring projections as shown, or they may comprise blades or other forms of protuberances which might facilitate grinding. Any of the grinding arms 1880 may comprise one or more detectors 1841 disposed therein in any desired configuration. FIGS. 21-24 show various other embodiments of grinding mills incorporating detectors and sensors for determining wear of a grinding element. For instance, FIG. 21 shows a horizontal grinding mill 1900 comprising a housing 1908 having a plurality of sensors 1920 thereon. A rotor assembly 1901 comprising a shaft 1902 and a plurality of eccentric grinding flanges 1906 thereon rotates within the housing 1908. The eccentric grinding flanges 1906 may be arranged in any particular order on the shaft 1902; however, in preferred embodiments, the eccentric grinding flanges 1906 are circumferentially and axially spaced and arranged uniformly around the shaft 1902. The eccentric grinding flanges 1906 may comprise one or more passages 1907 for grinding media and/or slurry to pass through. At least one eccentric grinding flange may comprise one or more detectors 1941 which are capable of indicating a state of wear of the at least one eccentric grinding flange.

FIG. 22 shows a horizontal grinding mill 2000 comprising a hollow housing 2008 having a sensor 2020 therein. A rotor assembly 2001 comprising a shaft 2002 and a plurality of inner grinding nubs/ribs 2006a thereon rotates within the housing 2008. Inner portions of the housing comprise one or more outer grinding nubs/ribs 2006b. The inner and outer grinding nubs/ribs 2006a, 2006b may be arranged in any particular order on the shaft 2002 or housing 2008; however, in preferred embodiments, the grinding nubs/ribs 2106a, 2106b are circumferentially and/or axially spaced and arranged uniformly within the grinding mill 2000. Any of the inner grinding nubs/ribs 2006a may comprise one or more detectors 2041a which are capable of indicating a state of wear of its respective inner grinding nub/rib 2006a. Any of the outer grinding nubs/ribs 2006b may comprise one or more detectors 2041b which are capable of indicating a state of wear of its respective outer grinding nub/rib 2006b. While not shown, any of the inner or outer grinding nubs/ribs 2006a, 2006b may comprise passages for grinding media and/or slurry to pass.

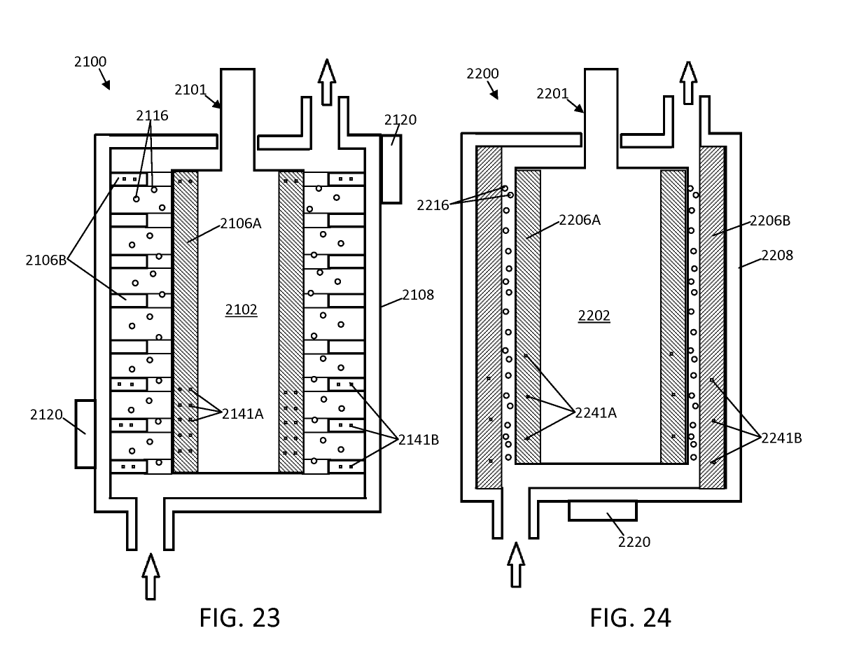

Turning now to FIG. 23, a grinding mill 2100 comprising a housing 2108 and a rotor assembly 2101 therein is shown. The rotor assembly 2101 may comprise a rotatable shaft 2102 having a shaft liner 2106a. The shaft liner 2106a may comprise one or more detectors 2141a provided therein in any configuration or manner. The housing 2108 may comprise a series of grinding discs 2106b having an annular shape and which surround the shaft liner 2106a. The annular grinding discs 2106b provide a tortuous path for grinding media 2116 and slurry to flow and help prevent migration of grinding media 2116. The annular grinding discs 2106b, while not shown, may comprise one or more passages such as apertures therein or cutout portions in its outer profile to further allow grinding media 2116 and slurry to pass. The annular grinding discs 2106b may comprise one or more detectors 2141b provided therein in any configuration or manner. In the particular embodiment shown, only upper discs 2106b and lower discs 2106b comprise detectors 2141b. However, all or other discs 2106b may comprise detectors 2141b without limitation. One or more sensors 2120 are provided to the housing 2108 to receive information from the detectors 2141a, 2141b. Depending on the amount of wear to either the shaft liner 2106a and/or the annular grinding discs 2106b, the sensors may not pick up a signal from every detector 2141a, 2141b. In such instances, when a signal from a particular detector 2141a, 2141b ceases to be read by the sensor, an alarm is tripped indicating that a predetermined amount of wear has been realized at the location of said particular detector 2141a, 2141b.

FIG. 24 shows an alternative embodiment of a grinding mill 2200, comprising a housing 2208 and a rotor assembly 2201. The rotor assembly 2201 may comprise a rotatable shaft 2202 having a shaft liner 2206a. The shaft liner 2206a may comprise one or more detectors 2241a provided therein in any configuration or manner. The housing 2208 may comprise a series of housing liner 2206b having an annular, cylindrical, and/or tubular shape and which surround the shaft liner 2206a. Grinding media 2216 and slurry flows between the housing liner 2206b and the shaft liner 2206a. The housing liner 2206b may comprise one or more detectors 2241b provided therein in any configuration or manner. In the particular embodiment shown, only lower regions of housing liner 2206b and shaft liner 2206a comprise detectors 2141a, 2141b. However, other portions of housing liner 2206b and shaft liner 2206 may comprise detectors 2241a, 2241b without limitation. At least one sensor 2220 is provided to the housing 2208 to receive information from the detectors 2241a, 2241b. Depending on the amount of wear experienced by either the shaft liner 2206a and/or the housing liner 2206b, the sensor may not pick up a signal from every detector 2241a, 2241b. In such instances, when a signal from a particular detector 2241a, 2241b ceases to be read by the sensor, an alarm is tripped indicating that a predetermined amount of wear has been realized at the location of said particular detector 2241a, 2241b.

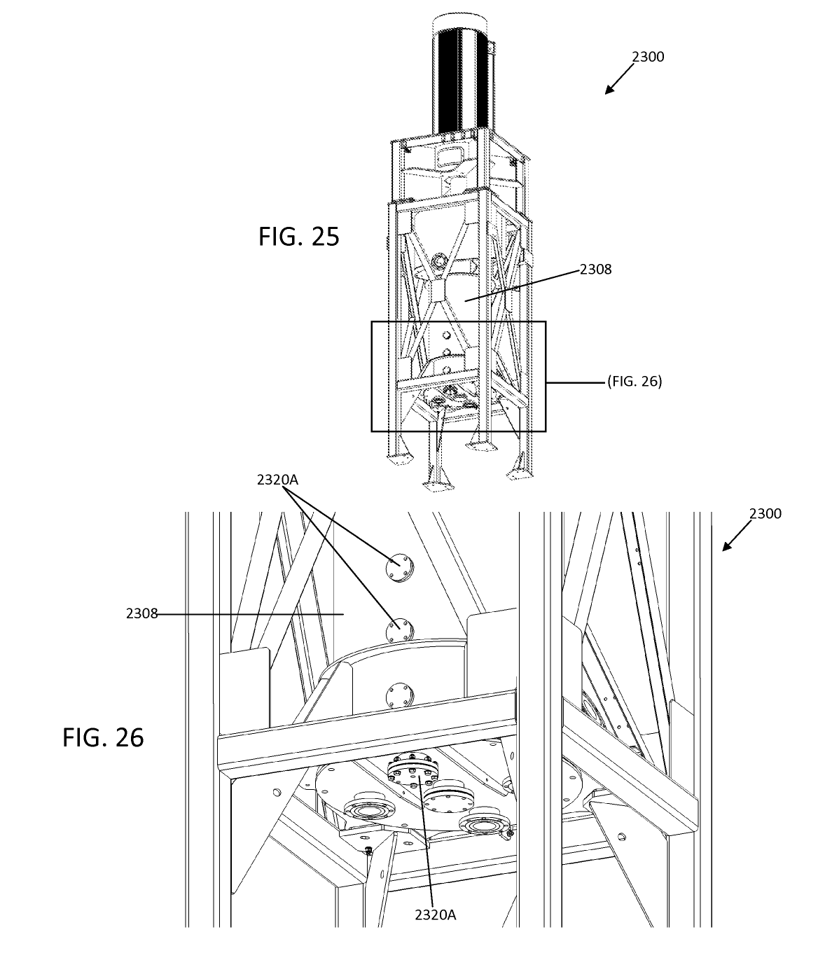

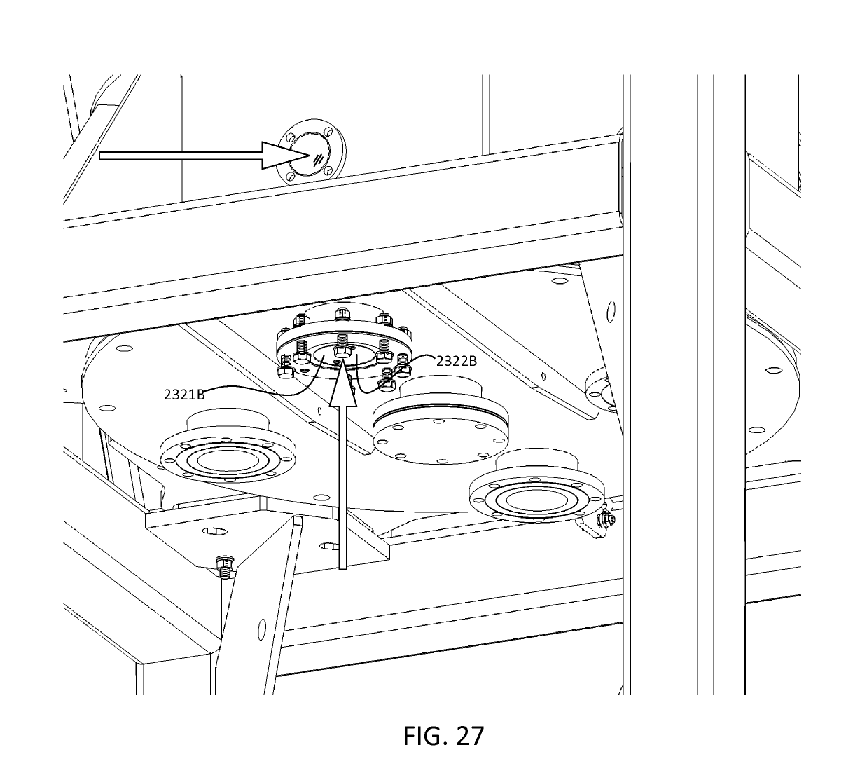

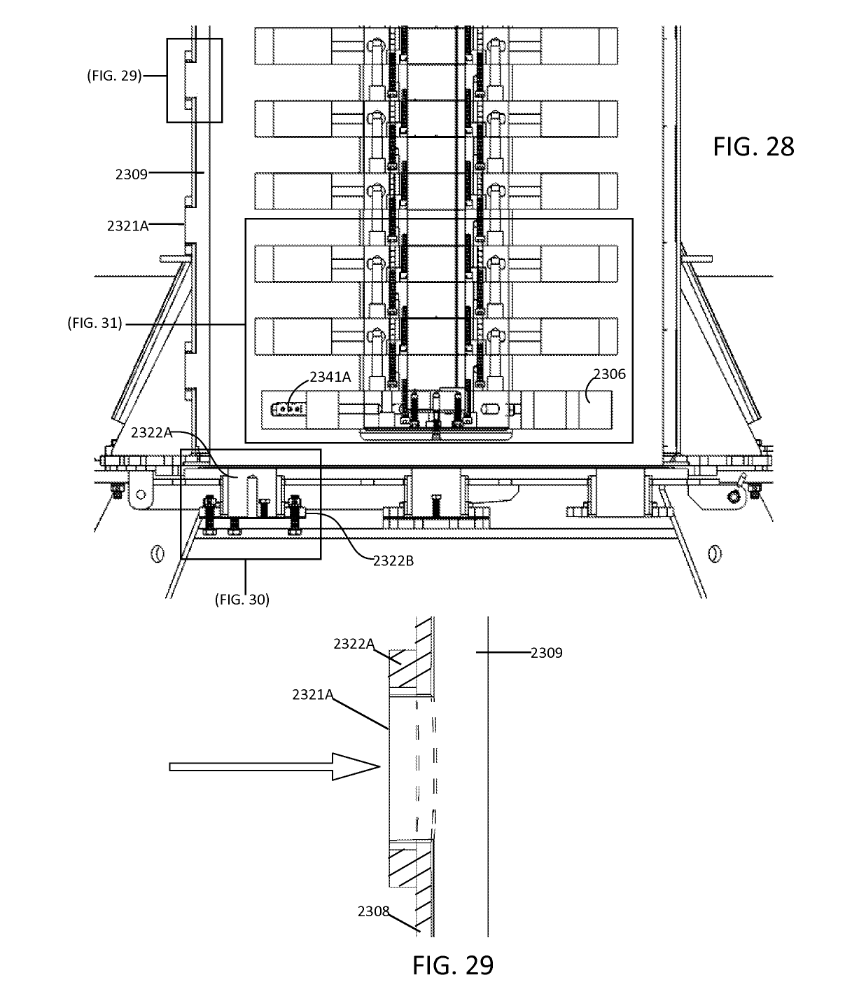

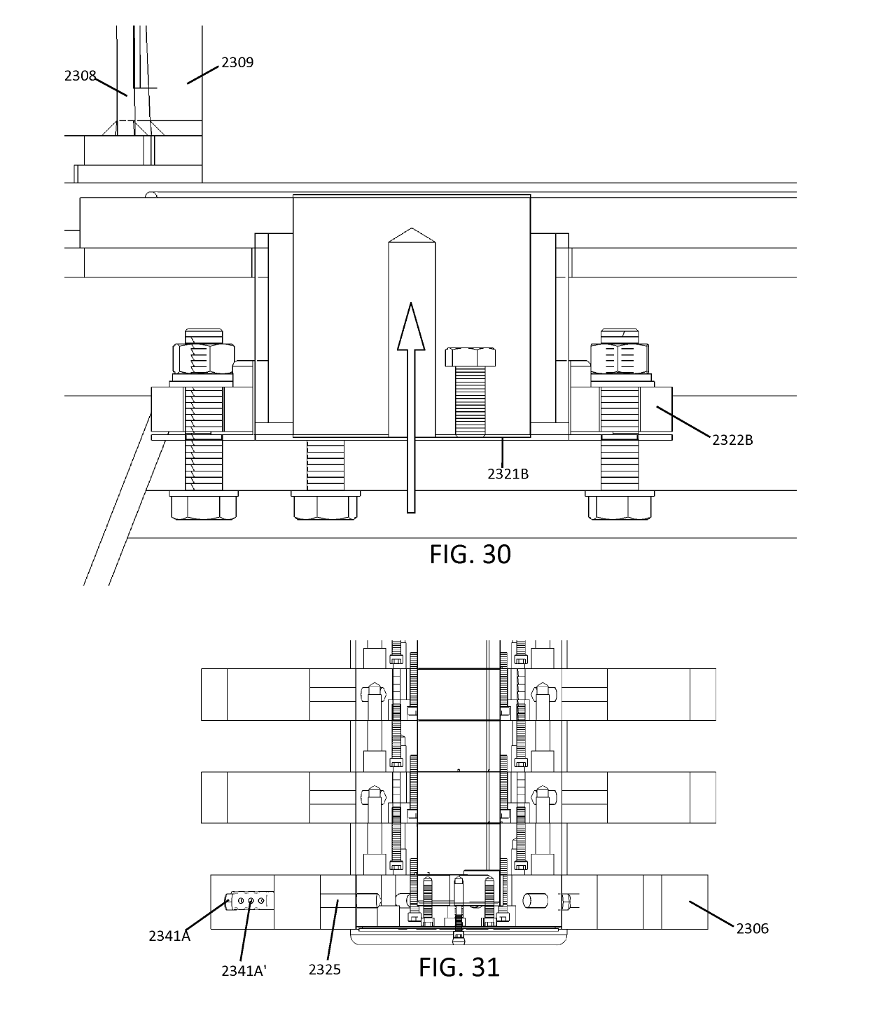

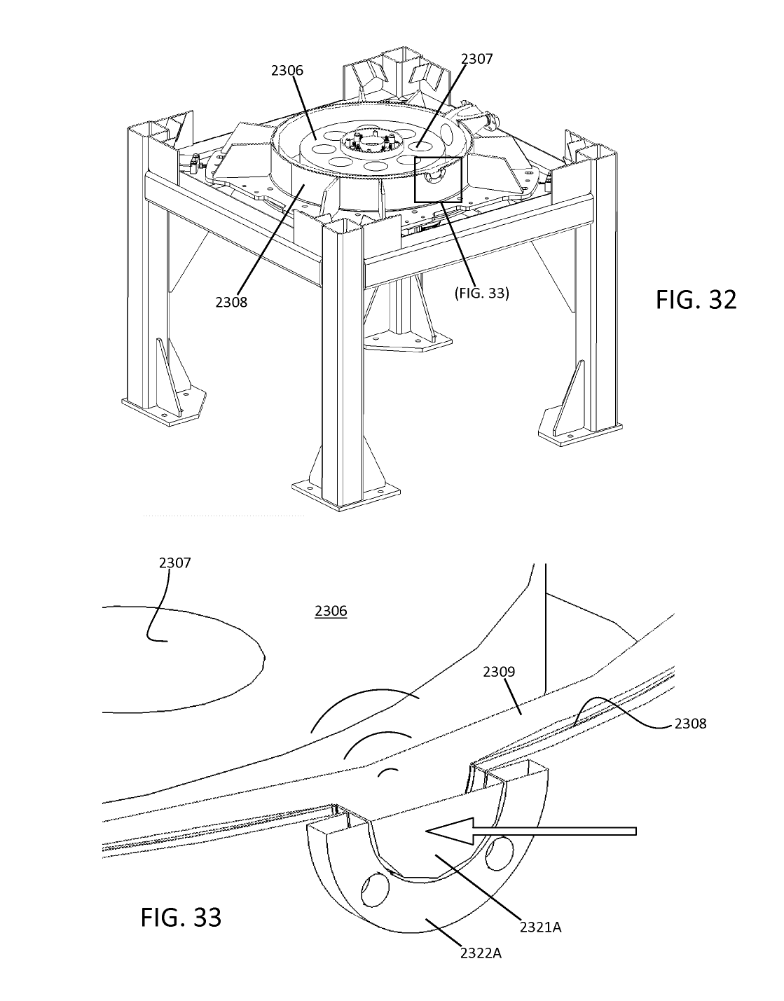

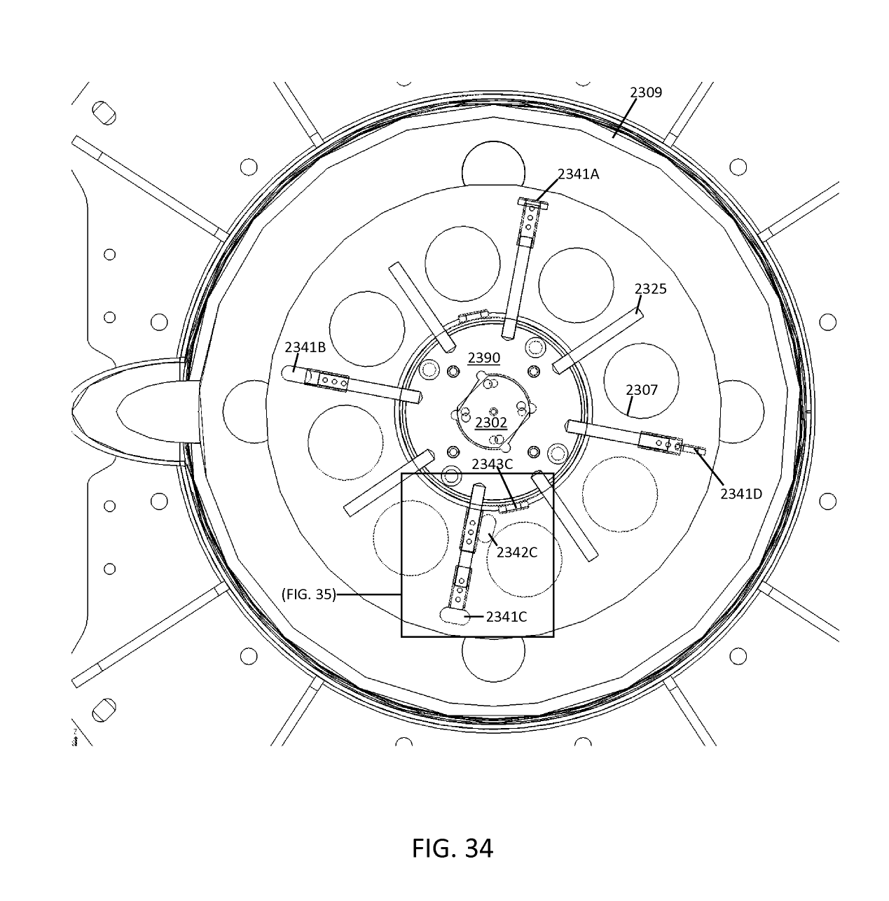

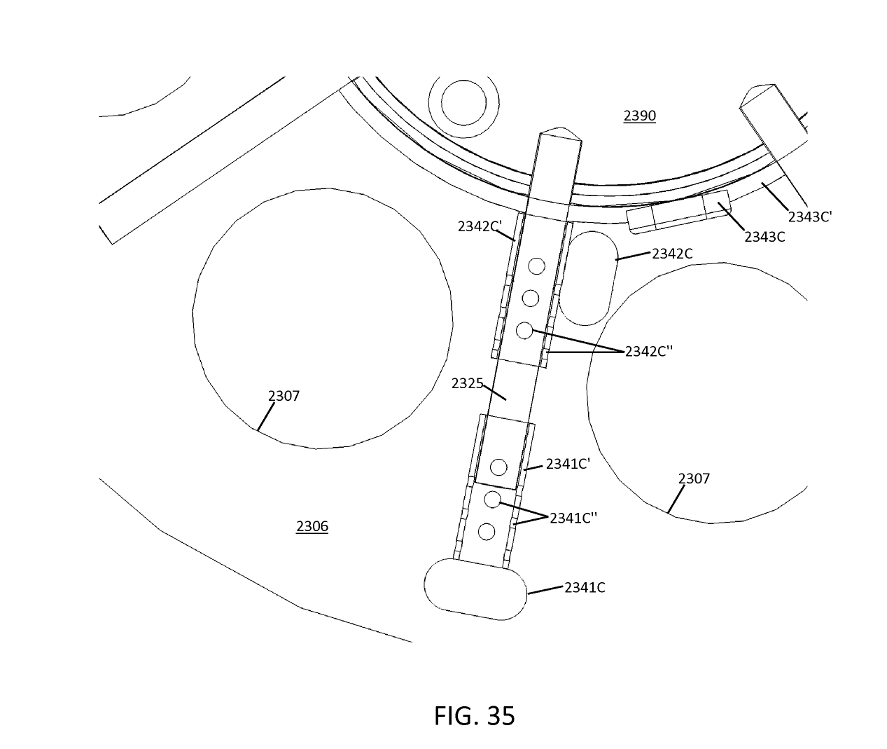

Turning now to FIGS. 25-35, a fine grinding mill 2300 according to some embodiments may comprise a shaft 2302 containing a number of grinding discs 2306. One or more of the grinding discs 2306 may comprise an inner portion 2390 having one or more spokes 2325. The one or more spokes 2325 may comprise one or more detectors 2341A, 2341A, 2341D. In some embodiments, a single spoke 2325 may comprise a plurality of detectors. For instance, as shown in FIG. 35, a spoke 2325 may comprise a first detector 2341C, a second detector 2342C provided radially inward of the first detector 2341C, and a third detector 2343C provided even further radially inward of the second detector 2343 which would signal a maximum amount of wear to a grinding disc 2306 before wear begins to affect the inner portion 2390 or shaft 2302. Detectors may comprise a detector mount 2341A′, 2341C′, 2342C′, 2342C′, such as a sleeve, that may be slid over or secured onto the spokes 2325 prior to molding a grinding disc 2306. In some instances, the detector mount may have a “bottoming” feature that caps a spoke 2325 and sets a calibrated distance of a detector 2342C from an outer peripheral circumference of a disc 2306. The detector mounts may comprise detector mount fastening means 2341C″, 2342C″, such as a number of ridges, holes, or set screws to secure the detectors to the spokes 2325 prior to, and during molding of the grinding discs 2306.

Each grinding disc 2306 may comprise a plurality of passages 2307 for allowing slurry and grinding media to advance between grinding discs 2306.

The housing 2308 of the grinding mill 2300 may comprise an inner housing liner 2309 which is preferably made from a non-metal (e.g., polyurethane). A plurality of side read zones 2321A may be employed to the housing 2308 and/or housing liner 2309, and one or more side read covers 2320A may be provided over the side read zones 2321A to protect the side read zones 2321A from external elements. Removing the side read covers 2320A exposes the non-metal (e.g., polyurethane) inner housing liner 2309, thereby reducing the chance of possible metallic interference between detectors and sensors. For example, removing the side read covers 2320A may improve sensor sensitivity and reduce interference, thereby facilitating detection and reading of a detector (e.g., with a sensor comprising a portable handheld RFID reader or equivalent mobile sensor device 220).

Similar to the side read covers 2320A, the housing 2308 may comprise one or more lower read covers 2320B adjacent one or more lower read zones 2321B. The covers 2320B may have a central aperture or through hole, or may be solid. Upon removal of the lower read cover(s) 2320B, a deep blind aperture may be provided and an antenna from a sensor may be inserted therein. In some preferred embodiments, the antenna may be from a sensor comprising a portable handheld RFID reader or equivalent mobile sensor device 220).

Side read covers 2320A and lower read covers 2320B may comprise fastening means, such as an integral screw thread, or holes for bolts or other fasteners. In this regard, the side read covers 2320A and lower read covers 2320B may be securely fastened to side read cover mounts 2322A and/or lower read cover mounts 2322B provided to housing 2308.

Although the invention has been described in terms of particular embodiments and applications, one of ordinary skill in the art, in light of this teaching, can generate additional embodiments and modifications without departing from the spirit of or exceeding the scope of the claimed invention. For example, while it is envisaged that the invention may have the most practicality with production grinding mills ranging from 150 KW to 3000 KW or more, various aspects of the invention (whether alone or in combination) may be incorporated in a lab-size grinding mills (e.g., 10 liter), 2 meter grinding mills suitable for metallurgical testing, pilot-size mills (e.g., a 50 liter modular/mobile unit), or full-size production grinding mills (e.g., 1000 L, 2000 L, 2500 L, or larger), without limitation. Moreover, the invention may be practiced with grinding mills having vertical, inclined, declined, or horizontal configurations, or other types of milling apparatus. For instance, the technology described herein may be implemented on vertical roller mills, high-pressure grinding roll (HPGR) mills, or fine grinding mills which incorporate rotating housings and stationary or counter-rotating rotor assemblies. Detectors discussed herein may comprise active reader passive tags (ARPT), active reader active tags (ARAT), or battery-assisted passive (BAP) tags without limitation, and they may operate at any preferred frequency within any useable band including: LF (120-150 kHz) for distances between detectors and sensors under 0.1 meters, HF (13.56 MHz) for distances between detectors and sensors under 1 meters. The detectors discussed herein may also operate within the UHF (e.g., 433 MHz, 865-868 MHz, or 902-928 MHz) or microwave (2450-5800 MHz) spectrums for much larger distances between detectors and sensors. In some embodiments, the detectors discussed herein may comprise multi-frequency (MF) RFID tags, and the sensors discussed herein may comprise a multi-frequency reader. In some embodiments, detectors discussed herein may comprise self-powered RF-emitting wireless micro-transmitters (e.g., comprising radioisotope batteries), and sensors discussed herein may comprise receivers tuned to the same frequency as said RF-emitting wireless micro-transmitters. In some embodiments, data may be provided in a programmable automation controller (PAC) or programmable logic controller (PLC) that is addressable from a plant control network. In such instances, OPC (i.e., object linking and embedding OLE for process control) and the high overhead/complexities of distributed component object model (DCOM) configurations may be avoid by using other common protocols such as Ethernet/IP, Modbus (RTU-, ASCII-, or TCP-frame formats), and/or combinations thereof (e.g., Modbus TCP/IP open-mbus).

It should be further noted that the particular geometries of components shown in the drawings are merely schematic representations and may vary from what is shown, and it is anticipated by the inventor that any number of variations and/or combinations of features or elements described herein may be practiced without departing from the scope of the invention. For example, while multiple detectors 141a, 142a, 143a may be shown as being arranged in a generally radial alignment within a disc 106a, they may be alternatively or also aligned in a direction generally parallel to the shaft axis 109 so as to detect a reduction in thickness of a disc 106a as well as a reduction in diameter of a disc 106a. Moreover, detectors (where used herein) may be swapped for sensors (where used herein) without limitation. For example, in FIG. 1, detectors 141a-e may be provided on the housing 108 or a liner of housing 108, and the sensors 120 may be provided within discs 106a-e. Alternatively, detectors may be omitted and only sensors may be provided within each disc 106a-e. In such instances, when the sensor of a particular disc stops working, the respective disc has reached a predetermined amount of wear. Accordingly, it is to be understood that the drawings and descriptions herein are proffered by way of example to facilitate comprehension of the invention and should not be construed to limit the scope thereof.

### REFERENCE NUMERAL IDENTIFIERS

| | |
|---|---|
| 100, 200, 1900, 2000, 2100, 2200, 2300 | Fine grinding mill |
| 101, 201, 1601, 1701, 1801, 1901, 2001, | Rotor assembly |
| 2101, 2201 | |
| 102, 202, 302, 1202, 1602, 1702, 1802, | Shaft |
| 1902, 2002, 2102, 2202, 2302 | |
| 103, 203 | Coarse slurry holding device |
| 104, 204 | Inlet |
| 105, 205 | Course slurry |
| 106a-e, 206, 206a-e, 306a-e, 406, 506, | Grinding disc |
| 606, 706, 806, 906, 1006, 1106, 1206a-e, | |
| 2306 | |
| 107, 207, 807, 907, 1907, 2307 | Passage |
| 108, 208, 308, 1208, 1908, 2008, 2108, | Housing |
| 2208, 2308 | |
| 109, 209 | Axis |
| 110, 210 | Launder |
| 111, 211 | Screen |
| 112, 212 | Rotation direction |
| 113, 213 | Fine slurry |
| 114, 214 | Outlet |
| 115, 215 | Fine slurry holding device |
| 116, 216, 2116, 2216 | Grinding media |
| 117, 217 | Drive |
| 118, 218 | Motor |
| 119, 219 | Frame |
| 120a-e, 220, 320, 1220, 1920, | Sensor |
| 2020, 2120, 2220 | |
| 121, 221 | Structural member |
| 122, 222 | End cap |
| 141a-e, 241a-e, 341a-e, 841, 941 | First detector |
| 2341C | |
| 142a-e, 242a-e, 842, 942, 2342C | Second detector |
| 143a-e, 243a-e, 843, 943, 2343C | Third detector |
| 160, 260 | Human machine interface |
| | (HMI) computer |
| 251a | First check signal |
| 252a | Second check signal |
| 253a | Third check signal |
| 261a | First confirmation signal |
| 262a | Second confirmation signal |
| 263a | Third confirmation signal |
| 351, 1251 | First check signal |
| 352, 1252 | Second check signal |
| 353, 1253 | Third check signal |
| 354, 1254 | Fourth check signal |
| 355, 1255 | Fifth check signal |
| 361, 1261 | First confirmation signal |
| 362, 1262 | Second confirmation signal |
| 363, 1263 | Third confirmation signal |
| 364, 1264 | Fourth confirmation signal |
| 365, 1265 | Fifth confirmation signal |
| 472, 572, 672, 772 | Cavity |
| 441, 541, 641, 741, 1141, | Detector |
| 1241a-e, 1641, 1741, 1841, 1941 | |
| 402, 702 | Threaded receiving portion |
| 471 | Threaded insert |
| 571 | Cover plug |
| 771 | Cover cap |
| 773 | Fastening means |
| 774 | Aperture |
| 850, 950, 1050, 1150 | Shaft attachment feature |
| 925, 1725 | Fastening means |
| 980, 1680, 1780 | Outer portion |
| 990, 1690, 1790, 2390 | Inner portion |
| 1006a | First sandwich portion |
| 1006b | Second sandwich portion |
| 1006c | Outer coating |
| 1010, 1110, 1210 | Connection |
| 1011, 1111, 1211 | Wire |
| 1041 | Wear plate |
| 1192 | Outer edge |
| 1192a-d | Wear line |
| 1300 | Method of wear monitoring |
| 1302-1314 | Method steps |
| 1400 | Control display |
| 1401 | Rotor overall condition icon |
| 1402 | Real-time wear profile |
| 1403 | Representative rotor image |
| 1404 | Set of disc number icons |
| 1405 | Set of disc status icons |
| 1406 | Disc #4 replacement alert |
| | icon (red) |
| 1407 | Disc #5 replacement alert |
| | icon (red) |
| 1408 | Disc #6 warning alert |
| | icon (yellow) |
| 1409 | Sensor overall condition icon |
| 1880 | Grinding arm |
| 1906 | Eccentric grinding flange |
| 2006a | Inner grinding nub/rib |
| 2006b | Outer grinding nub/rib |
| 2041a, 2141a, 2241a | Inner set of one or more |
| | detectors |
| 2041b, 2141b, 2241b | Outer set of one or more |
| | detectors. |
| 2106a, 2206a | Shaft liner |
| 2106b | Annular grinding disc |
| 2206b, 2309 | Housing liner |
| 2320A | Side read cover |
| 2320B | Lower read cover |
| 2321A | Side read zone |
| 2321B | Lower read zone |
| 2322A | Side read cover mount |
| 2322B | Lower read cover mount |
| 2325 | Spokes |
| 2341A, 2341A, 2341D | Detector |
| 2341A′, 2341C′, 2342C′, 2342C′ | Detector mount |
| 2341C″, 2342C″ | Detector mount fastening |
| | means |

What is claimed is:

1. A system for the continuous monitoring of wear comprising:
(a) a grinding mill (100) comprising at least one grinding element (106);
(b) at least one detector (141) provided to the at least one grinding element (106); and
(c) at least one sensor (120) provided to the grinding mill (100) which is configured to communicate with the at least one detector (141) during operation of the grinding mill (100);
wherein in use, the at least one grinding element (106) wears away and ultimately affects a function of the least one detector (141); and,
wherein, by virtue of communication with the at least one detector (141), the at least one sensor (120) is configured to monitor said function of the least one detector (141) and determine an operational status of the at least one grinding element (106).

2. The system of claim 1, wherein the at least one detector (141) comprises an RFID tag and the at least one sensor (120) comprises a reader/interrogator.

3. The system of claim 2, wherein the at least one detector (141) comprises a low-frequency RFID tag, and the at least one sensor (120) comprises a low-frequency detector/identifier in the kHz range of frequencies.

4. The system of claim 2, wherein the at least one detector (141) comprises an ultra-high frequency RFID tag, and the at least one sensor (120) comprises an ultra-high frequency detector/identifier in the MHz range of frequencies.

5. The system of claim 2, wherein the at least one detector (141) comprises a microwave RFID tag, and the at least one sensor (120) comprises a microwave detector/identifier which operates in the GHz range of frequencies.

6. The system of claim 1, wherein the at least one detector (141) comprises a magnet and the at least one sensor (120) comprises a Hall Effect sensor.

7. The system of claim 1, wherein the at least one detector (141) comprises a wafer-style probe comprising a printed circuit board (PCB).

8. The system of claim 1, wherein the at least one detector (141) comprises a radioisotope capable of emitting alpha particles and/or low energy gamma rays, and the at least one sensor (120) comprises a radioisotope detector/identifier, wherein the at least one sensor (120) detects the radioisotope when the at least one detector (141) is exposed after a predetermined amount of grinding element (106) wear.

9. The system of claim 1, wherein the at least one detector (141) comprises a self-powered RF-emitting wireless micro-transmitter, and the at least one sensor (120) comprises a receiver tuned to the same frequency as said RF-emitting wireless micro-transmitter.

10. The system of claim 1, wherein the at least one detector (141) is communicates with the sensor (120) wirelessly.

11. The system of claim 1, wherein the at least one detector (141) is hardwired to the at least one sensor (120) to facilitate communication therebetween.

12. The system of claim 1, wherein multiple detectors (141) are provided to the at least one grinding element (106).

13. The system of claim 1, wherein at least one detector (141a, 142a, 143a; 141b, 142b, 143b) is provided to multiple grinding elements (106a, 106b) within the grinding mill (100).

14. The system of claim 13, wherein a first detector (341a) in a first grinding element (306a) is provided at a radial location which is different than the radial location of a second detector (341b) in a second grinding element (306b).

15. The system of claim 1, wherein the grinding element (106) comprises at least one of a grinding disc (106a-e, 206, 206a-e, 306a-e, 406, 506, 606, 706, 806, 906, 1006, 1106, 1206a-e), an annular grinding disc (2106b), an inner grinding nub/rib (2006a), outer grinding nub/rib (2006b), a shaft liner (2106a, 2206a), and a housing liner (2206b).

16. A grinding disc (806) for use in a grinding mill (100):
(a) a shaft attachment feature (850); and,
(b) at least one detector (841, 842, 843) configured to communicate with a sensor (120) provided to the grinding mill (100);
wherein in use, the at least one grinding disc (806) is configured to wear away ultimately affecting a function of the least one detector (841, 842, 843); and,
wherein, by virtue of communication with said sensor (120), the at least one detector (841, 842, 843) is configured to aid in determining an operational status of the at least one grinding disc (806).

17. The grinding disc of claim 15, wherein the at least one detector (841, 842, 843) comprises an RFID tag.

18. The grinding disc of claim 15, wherein the at least one detector (841, 842, 843) comprises a magnet.

19. The grinding disc of claim 15, wherein the at least one detector (841, 842, 843) comprises a wafer-style probe comprising a printed circuit board (PCB).

20. The grinding disc of claim 15, wherein the at least one detector (841, 842, 843) comprises a radioisotope capable of emitting alpha particles and/or low energy gamma rays.

21. The grinding disc of claim 15, wherein multiple detectors (841, 842, 843) are provided to the at least one grinding disc (806).

22. The grinding disc of claim 20, wherein said multiple detectors (841, 842, 843) are provided to different radial or circumferential portions of the at least one grinding disc (806).

23. The grinding disc of claim 20, wherein said at least one detector (841, 842, 843) is provided to the disc (806) as a separate component.

24. The grinding disc of claim 20, further comprising a cavity (472, 572, 772, 1572) and one or more threaded inserts (471), cover plugs (571), cover caps (771), or tapered cover plugs (1571).

25. The grinding disc of claim 20, wherein at least one detector (841, 842, 843) is molded into a cavity (672) in the disc (806).
